(19) United States
(12) Patent Application Publication
(10) Pub. No.: US 2023/0174790 A1
(43) Pub. Date: Jun. 8, 2023

(54) A Dual-Reactive Coating Composition, Its Preparation and Use Thereof

(71) Applicant: BASF COATINGS GMBH, Münster (DE)

(72) Inventors: Christian Gerhard SCHAEFER, Shanghai (CN); Hugo VALE, Ludwigshafen (DE); Stefan HIRSEMANN, Shanghai (CN); Xiao Hui LI, Shanghai (CN); Yang ZHANG, Shanghai (CN); Maik SCHLESINGER, Ludwigshfen (DE); Cathrin CORTEN, Münster (DE); Jan BENNEWITZ, Ludwigshafen (DE); Werner-Alfons JUNG, Ludwigshafen (DE)

(21) Appl. No.: 17/997,984

(22) PCT Filed: May 3, 2021
(86) PCT No.: PCT/EP2021/061527

§ 371 Date: Nov. 4, 2022

(30) Foreign Application Priority Data
May 7, 2020 (CN) PCT/CN2020/089014

(51) Int. Cl. C09D 4/06; C09D 183/06; C09D 175/14

(52) U.S. Cl. CPC C09D 4/06; C09D 183/06; C09D 175/14

(57) ABSTRACT

Disclosed herein is a dual-reactive composition including a). from 24% to 90% by weight of crosslinkable silane-functional monomer and/or oligomer and/or polymer; b). from 9% to 75% by weight of one monomer and/or unsaturated oligomer and/or unsaturated polymer; c). from 0.5% to 10% by weight of one initiator; and d). from 0.5% to 10% by weight of one catalyst, all weight percentages are based on the total weight of the coating composition and a film obtained from curing and drying of the coating composition as well as a substrate coated with the dual-reactive coating composition. Additionally disclosed herein is a process for preparing the dual-reactive coating composition and a roll-to-roll coating composition and a 1K clearcoat composition including the dual-reactive coating composition.

### TECHNICAL FIELD

This invention relates to a dual-reactive coating composition, more specifically, relates to a dual-reactive coating composition used as topcoat of automobile as well as its preparation and use thereof.

### BACKGROUND

Nanocomposites are materials composed of inorganic nanoparticles finely dispersed in continuous polymer matrices. Inorganic nanoparticles are in most cases produced by a sol-gel process, starting from respective precursors that are hydrolyzed and condense to form particles of different morphology. Transparent organic-inorganic composite films can be prepared by dispersing preformed particles either in polymers by using common polymer processing such as extrusion, or by dispersing them in monomers, and then allowing the polymerization to form a continuous polymer phase. However, in both cases the structures of the organic and inorganic phases, the phase morphology, and the presence of covalent bonds between the two phases significantly influence the properties of these composites.

For automotive coatings, where a high degree of visual appearance as well as long-term durability is required, reactive polymer systems with silane functional groups are potentially attractive in order to provide conventional coatings with new properties on the basis of organic-inorganic composites, e.g. enhancement of scratch resistance and chemical resistance, and at the same time, to enable a different curing approach while fulfilling environmental demands.

Hybrid silane-containing polymers have so far widespread applications in moisture reactive sealants and adhesives as well as construction materials. Those reactive resins have hydrolysable alkoxysilanes as end groups or on the side chains that react through a hydrolytic mechanism to form silsesquioxane networks. The finely dispersed inorganic domains provide the polymer matrix with excellent properties, such as good chemical resistance, improved scratch resistance, good weatherability as well as refined surface adhesion. However, some general drawbacks of reactive silane-based systems are the appearance of post curing, cracking and phase separation which lead to decrease of performance, e.g. durability, chemical resistance, appearance, etc. and thus strongly restrict the use in automotive coatings.

### SUMMARY OF THE INVENTION

In one aspect, this invention provides a dual-reactive coating composition comprising

a). from 24% to 90% by weight of crosslinkable silane-functional monomer and/or oligomer and/or polymer;
b). from 9% to 75% by weight of one unsaturated monomer and/or oligomer and/or polymer;
c). from 0.5% to 10% by weight of one initiator; and
d). from 0.5% to 10% by weight of one catalyst, all weight percentages are based on the total weight of the coating composition.

In another aspect, this invention provides a dual-reactive coating composition comprising

a). from 24% to 90% by weight of crosslinkable silane-functional monomer and/or oligomer and/or polymer;
b). from 9% to 75% by weight of unsaturated polyester and/or polyurethane-modified oligomer and/or polyester-modified oligomer;
c). from 0.5% to 10% by weight of one initiator; and
d). from 0.5% to 10% by weight of one catalyst, all weight percentages are based on the total weight of the coating composition.

In another aspect, this invention provides a dual-reactive coating composition comprising

a). from 24% to 90% by weight of crosslinkable silane-functional polymer;
b). from 9% to 75% by weight of unsaturated polyester;
c). from 0.5% to 10% by weight of one initiator; and
d). from 0.5% to 10% by weight of one catalyst, all weight percentages are based on the total weight of the coating composition.

In another aspect, this invention provides a film obtained from curing and drying of the invented dual-reactive coating composition.

In another aspect, this invention provides a substrate coated with the invented dual-reactive coating composition.

In another aspect, this invention provides a process for preparing the invented dual-reactive coating composition by mixing

a). from 24% to 90% by weight of crosslinkable silane-functional monomer and/or oligomer and/or polymer;
b). from 9% to 75% by weight of one unsaturated monomer and/or oligomer and/or polymer;
c). from 0.5% to 10% by weight of one initiator; and
d). from 0.5% to 10% by weight of one catalyst, all weight percentages are based on the total weight of the coating composition.

In another aspect, this invention provides a process for preparing the invented dual-reactive coating composition by mixing

a). from 24% to 90% by weight of crosslinkable silane-functional monomer and/or oligomer and/or polymer;
b). from 9% to 75% by weight of unsaturated polyester and/or polyester-modified oligomer;
c). from 0.5% to 10% by weight of one initiator; and
d). from 0.5% to 10% by weight of one catalyst, all weight percentages are based on the total weight of the coating composition.

In another aspect, this invention provides a process for preparing the invented dual-reactive coating composition by mixing

a). from 24% to 90% by weight of crosslinkable silane-functional polymer;
b). from 9% to 75% by weight of unsaturated polyester;
d). from 0.5% to 10% by weight of one catalyst, all weight percentages are based on the total weight of the coating composition.

In another aspect, this invention provides a roll-to-roll coating composition comprising the invented dual-reactive coating composition, reactive diluent and additives, wherein the solid content of the obtained roll-to-roll coating composition is no less than 90% by weight and preferably no less than 95% by weight.

In a further aspect, this invention provides a 1K clearcoat composition comprising the invented dual-reactive coating composition, reactive diluent, additives and co-solvent, wherein VOC (volatile organic compounds) of the obtained clearcoat composition is no more than 420 g/L and preferably no more than 350 g/L.

It is surprisingly found that by using a dual-reactive system, the obtained coating laying shows good performance in durability, chemical resistance, appearance, etc.

### DETAILED DESCRIPTION OF THE INVENTION

The following terms, used in the present description and the appended claims, have definitions as below:

Expressions “a”, “an”, “the”, when used to define a term, include both the plural and singular forms of the term.

All percentages are mentioned by weight unless otherwise indicated.

The term “and/or” includes the meanings “and”, “or” and also all the other possible combinations of the elements connected to this term.

The term “oligomer”, as used herein, refers to homopolymers that have two to three repetitive units of a single monomeric compounds.

The term “1K”, as used herein, refers to a composition comprising one component which may be a mixture of several compounds.

The term “2K”, or “two-component”, as used herein, refers to a composition comprising two components, each of which may also be a mixture of several compounds. The two components can be blended together if needed. And the two components may also be two independent barrels that can be mixed on the spot for applications.

The term “solid content”, as used herein, refers to a weight percentage of non-volatile materials contained in a suspension such as coating, paint etc.

The term “dual-reactive”, as used herein, refers to two reactions in coating compositions i.e. (1) the polymerization of olefin double-bonds contained in monomer and/or oligomer and/or polymer and (2) he reaction of hydrolysable alkoxysilane or organoalkoxysilane groups in monomer and/or oligomer and/or polymer.

The term “crosslinkable silane-functional polymer”, as used herein, refers to polymer and copolymer containing crosslinkable silane function derived from the (co)polymerization of silane-functional monomers such as vinyl silane.

The term “crosslinkable silane-functional oligomer”, as used herein, refers to oligomer and co-oligomer containing crosslinkable silane function derived from the (co)oligomerization of silane-functional monomers such as vinyl silane.

The term “reactive-diluent”, as used herein, refers to substances which reduce the viscosity of a coating for processing and subsequently become part of the coating via (co)polymerization with any other component(s) of the coating.

The term “co-solvent”, as used herein, refers to substances added to a primary solvent or reactive diluent in small amounts to increase the solubility of a poorly-soluble compound.

Silane-Functional Monomer and/or Oligomer and/or Polymer

The silane-functional monomer in this invention is preferably a vinyl alkoxy silane monomer. The vinyl groups will take part in radical polymerizations while the alkoxyl groups will undergo hydrolysis and (self)condensation reaction in the coating composition. Preferably, the vinyl alkoxy silane monomer is at least one selected from vinyl trimethoxy silane, vinyl methyl-dimethoxy silane, vinyl triethoxy silane, vinyl tris (2-methoxyethoxy) silane, vinyl tris (isopropoxy) silane and 3-methacryloxypropyl trimethoxysilane.

The silane-functional oligomer and/or polymer is an acrylosilane oligomer and/or polymer that is a polymerization product of 20% to 50% by weight of ethylenically unsaturated vinyl alkoxy silane monomers that are represented by the general formula I,

H₂C═CH—(CH₂)ₙ—Si—(R₁)ₘ(R₂)₃₋ₘ

wherein R₁ is an aryl or alkyl group having C₁-C₆, R₂ is an alkoxyl group having C1-C6, m is 0 or 1 and n is an integer from 0 to 3, 50% to 80% by weight of ethylenically unsaturated acrylate monomers and 0 to 30% by weight of ethylenically unsaturated monomer selected from one or both of styrenic and methacrylate monomer, based on the total weight of the acrylosilane polymer.

Said ethylenically unsaturated acrylate monomers are preferably alkyl acrylates having C1-C12 alkyl groups and more preferably at least one selected from methyl acrylate, ethyl acrylate, propyl acrylate, n-butyl acrylate, isobutyl acrylate, tert-butyl acrylate, pentyl acrylate, ethyl hexyl acrylate, nonyl acrylate and lauryl acrylate. Cycloaliphatic acrylates could be used such as isobornyl acrylate, trimethylcyclohexyl acrylate, and t-butyl cyclohexyl acrylate. Aryl acrylates could be used such as benzyl acrylate. Polyacrylate monomers could be used such as 1,3 butanediol diacrylate, cyclohexanedimethanol diacrylate, neopolyacrylate monomers could be used such as 1,3-butanediol diacrylate, 1,4-butanediol diacrylate, 1,6-hexandediol diacrylate, cyclohexanedimethanol diacrylate, neopentyl glycol diacrylate, pentaerythritol triacrylate, trimethylolpropane triacrylate, diurethane diacrylates, urethane triacrylates. Other acrylate monomers could also be used such as silane-functional acrylates. Mixtures of above-mentioned monomers could be used as well.

Said methacrylate monomers are preferably alkyl methacrylate monomers and more preferably at least one selected from methyl methacrylate, ethyl methacrylate, propyl methacrylate, butyl methacrylate, isobutyl methacrylate, pentyl methacrylate, hexyl methacrylate, ethyl hexyl methacrylate, octyl methacrylate, nonyl methacrylate and lauryl methacrylate. Cycloaliphatic methacrylates could be used such as trimethylcyclohexyl methacrylates and t-butyl cyclohexyl methacrylate. Aryl methacrylates could be used such as benzyl methacrylate. Said styrenic monomers are preferably vinyl aromatics such as styrene and methyl styrene.

The acrylosilane polymer could comprise hydroxy functional groups that are provided by hydroxy alkyl acrylates and methacrylates having C₁-C₄ alkyl groups such as hydroxy ethyl acrylate, hydroxy propyl acrylate, hydroxy butyl acrylate, hydroxy ethyl methacrylate, hydroxy propyl methacrylate and hydroxyl butyl methacrylate.

Preferably, the crosslinkable silane-functional oligomer or polymer has a weight average molecular weight below 30,000 and preferably below 20,000 and the crosslinkable silane-functional polymer has a hydroxyl value from 0 to 150 mg KOH/g and an acid value from 0 to 50 mg KOH/g.

The solvents used to form the acrylosilane polymer are petroleum distillates. Alcohols could be used such as methanol, ethanol, n-propanol, isopropanol, butanol, secbutanol, isobutanol and propanol. Ketones could be used such as acetone, butanone, pentanone, hexanone and methyl ethyl ketones. Alkyl esters of acetic, propionic and butyric acids could be used such as ethyl acetate, butyl acetate and amyl acetate. Ethers such as tetrahydrofuran, diethyl ether and ethylene glycol and polyethylene glycol monoalkyl and dialkyl ethers such as cellosolves and carbitols and glycols such as ethylene glycol and propylene glycol could be used as well. Above-mentioned monomers could be mixed for use.

Peroxy or Azo polymerization initiators could be used for preparing acrylosilane polymers, for example, benzoyl peroxide, di-tert-butyl peroxide, lauroyl peroxide, t-butyl peroxypivalate, t-butyl peroxy 2-ethylhexanoate, 2.2′-azobis-isobutyronitrile, 2,2′-azobis-2,4-dimethylvaleronitrile, 2,2′-azobis-methylbutyronitrile and 1,1′-azobis-cyanocyclohexane.

The present invention surprisingly found a synthetic procedure based on an optimized feeding strategy in which the composition of the monomer feed is changed in multiple steps during the reaction. These optimized feeding strategy lead to a homogeneous incorporation of vinyl alkoxy silane, and simultaneously, lead to significantly reduced monomer residues after polymerization.

The homogenous silane-functional polymers are obtained which have excellent film forming and crosslinking properties and provide excellent flexibility. Thus, the crack formation is substantially suppressed without adding any film-forming polymer or additives such as hardeners and plasticizers.

Preferably, said crosslinkable silane-functional polymer is prepared by a method comprising two steps: in the first step, vinyl alkoxy silane monomers, (meth)acrylate monomers and optional styrenic monomers and initiator are blended with an organic solvent and heated, and in the second step, (meth)acrylate monomers and optional styrenic monomers and initiator are added, wherein in the second step, said (meth)acrylate monomers and optional styrenic monomers are added in no less than two batches, and the time between each batch is no less than half an hour and the weight ratio between (meth)acrylate monomers and optional styrenic monomers added in each batch is from 1:15 to 15:1.

More preferably, said crosslinkable silane-functional polymer is prepared by a method comprising two steps: in the first step, vinyl alkoxy silane monomers, (meth)acrylate monomers and optional styrenic monomers and initiator are blended with an organic solvent and heated, and in the second step, (meth)acrylate monomers and optional styrenic monomers and initiator are added, wherein in the second step, said (meth)acrylate monomers and optional styrenic monomers are added in no less than four batches, and the time between each batch is no less than an hour and the weight ratio between (meth)acrylate monomers and optional styrenic monomers added in each batch is from 1:15 to 15:1.

As an example, a crosslinkable silane functional polymer is prepared as follows:

A reactor is charged with 100-500 parts by weight of Shellsol A and this initial charge is heated to 90-160° C. The reactor is placed under pressure (1.5-6.5 bar). Thereafter, over a period of 4-7 hours, an initiator solution (50-100 parts by weight of di-tert-butyl peroxide in 50-100 parts by weight of Shellsol A) is metered in at a uniform rate with stirring. Starting 0-30 min after the start of initiator feed, Feed 1 composed of ethylenically unsaturated vinyl alkoxy silane monomers is metered in at a uniform rate with stirring over a period of 0.5-2 hours. Starting 0-30 min after the start of initiator feed, 500-1500 parts by weight of Feed 2 to 6 consisting of methyl methacrylate and n-butyl acrylate in a weight ratio of 0.1 to 10 is metered in at a uniform rate with stirring over a period of 0.5-2 hours for each Feed. Following complete addition of the initiator solution (0-60 min after the end of the addition of the monomer mixture), the reactor is heated to 100-180° C. and stirring is continued for 5-90 minutes at the stated pressure, before a solution consisting of 5-50 parts by weight of di-tert-butyl peroxide in 5-50 parts by weight of Shellsol A is again added at a uniform rate over the course of 0.5-2 hours. Subsequently, the batch is held at the stated temperature and stated pressure for a further 0.5-2 hours. Thereafter, the reaction mixture is cooled to 25-80° C. and let down to atmospheric pressure.

As another example, a crosslinkable silane functional polymer is prepared as follows: A reactor is charged with 100-500 parts by weight of Shellsol A and this initial charge is heated to 90-160° C. The reactor is placed under pressure (1.5-6.5 bar). Thereafter, over a period of 4-7 hours, an initiator solution (50-100 parts by weight of di-tert-butyl peroxide in 50-100 parts by weight of Shellsol A) is metered in at a uniform rate with stirring. Starting 0-30 min after the start of initiator feed, Feed 1 composed of ethylenically unsaturated vinyl alkoxy silane monomers is metered in at a uniform rate with stirring over a period of 0.5-2 hour. Starting 0-30 min after the start of initiator feed, 500-1500 parts by weight Feed 2 to 6 consisting of styrene, methyl methacrylate and n-butyl acrylate in a weight ratio of 0.1 to 10 is metered in at a uniform rate with stirring over a period of 0.5-2 hours for each Feed. Following complete addition of the initiator solution (0-60 min after the end of the addition of the monomer mixture), the reactor is heated to 100-180° C. and stirring is continued for 5-90 minutes at the stated pressure, before a solution consisting of 5-50 parts by weight of di-tert-butyl peroxide in 5-50 parts by weight of Shellsol A is again added at a uniform rate over the course of 0.5-2 hours. Subsequently, the batch is held at the stated temperature and stated pressure for a further 0.5-2 hours. Thereafter, the reaction mixture is cooled to 25-80° C. and let down to atmospheric pressure.

As another example, a crosslinkable silane functional polymer is prepared as follows: A reactor is charged with 100-500 parts by weight of Shellsol A and this initial charge is heated to 90-160° C. The reactor is placed under pressure (1.5-6.5 bar). Thereafter, over a period of 4-7 hours, an initiator solution (50-100 parts by weight of di-tert-butyl peroxide in 50-100 parts by weight of Shellsol A) is metered in at a uniform rate with stirring. Starting 0-30 min after the start of initiator feed, Feed 1 composed of ethylenically unsaturated vinyl alkoxy silane monomers is metered in at a uniform rate with stirring over a period of 0.5-2 hours. Starting 0-30 min after the start of initiator feed, 500-1500 parts by weight of Feed 2 to 6 consisting of styrene, methyl methacrylate and ethylhexyl acrylate in a weight ratio of 0.1 to 10 is metered in at a uniform rate with stirring over a period of 0.5-2 hours for each Feed. Following complete addition of the initiator solution (0-60 min after the end of the addition of the monomer mixture), the reactor is heated to 100-180° C. and stirring is continued for 5-90 minutes at the stated pressure, before a solution consisting of 5-50 parts by weight of di-tert-butyl peroxide in 5-50 parts by weight of Shellsol A is again added at a uniform rate over the course of 0.5-2 hours. Subsequently, the batch is held at the stated temperature and stated pressure for a further 0.5-2 hours. Thereafter, the reaction mixture is cooled to 25-80° C. and let down to atmospheric pressure.

As another example, a crosslinkable silane functional polymer is prepared as follows: A reactor is charged with 100-500 parts by weight of butyl acetate and this initial charge is heated to 90-160° C. The reactor is placed under pressure (1.5-6.5 bar). Thereafter, over a period of 4-7 hours, an initiator solution (50-100 parts by weight of di-tert-butyl peroxide in 50-100 parts by weight of butyl acetate) is metered in at a uniform rate with stirring. After 0-30 min of start of initiator feed, 300-700 parts by weight of ethylenically unsaturated vinyl alkoxy silane monomers is metered in at a uniform rate with stirring over a period of 0.5-2 hour. In the first step, a monomer mixture consisting of 50-150 parts by weight of methyl methacrylate and 50-150 parts by weight of n-butyl acrylate is simultaneously metered in at a uniform rate with stirring over a period of 0.5-2 hours. In the second step, a monomer mixture consisting of 100-200 parts by weight of methyl methacrylate and 100-200 parts by weight of n-butyl acrylate is metered in at a uniform rate with stirring over a period of 0.5-2 hours. In the third step, a monomer mixture consisting of 50-150 parts by weight of methyl methacrylate and 50-150 parts by weight of n-butyl acrylate is metered in at a uniform rate with stirring over a period of 0.5-2 hours. In the fourth step, a monomer mixture consisting of 50-100 parts by weight of methyl methacrylate and 50-100 parts by weight of n-butyl acrylate is metered in at a uniform rate with stirring over a period of 0.5-2 hours. In the fifth step, a monomer mixture consisting of 25-75 parts by weight of methyl methacrylate and 25-75 parts by weight of n-butyl acrylate is metered in at a uniform rate with stirring over a period of 0.5-2 hours. Following complete addition of the initiator solution (0-60 min after the end of the addition of the monomer mixture), the reactor is heated to 100-180° C. and stirring is continued for 5-90 minutes at the stated pressure, before a solution consisting of 5-50 parts by weight of di-tert-butyl peroxide in 5-50 parts by weight of butyl acetate is again added at a uniform rate over the course of 0.5-2 hours. Subsequently, the batch is held at the stated temperature and stated pressure for a further 0.5-2 hours. Thereafter the reaction mixture is cooled to 25-80° C. and let down to atmospheric pressure.

As another example, a crosslinkable silane functional polymer is prepared as follows: A reactor is charged with 100-500 parts by weight of butyl acetate and this initial charge is heated to 90-160° C. The reactor is placed under pressure (1.5-6.5 bar). Thereafter, over a period of 4-7 hours, an initiator solution (50-100 parts by weight of di-tert-butyl peroxide in 50-100 parts by weight of butyl acetate) is metered in at a uniform rate with stirring. Starting 0-30 min after the start of initiator feed, Feed 1 composed of ethylenically unsaturated vinyl alkoxy silane monomers is metered in at a uniform rate with stirring over a period of 0.5-2 hours. Starting 0-30 min after the start of initiator feed, 500-1500 parts by weight of Feed 2 to 6 consisting of styrene, methyl methacrylate and n-butyl acrylate in a weight ratio of 0.1 to 10 is metered in at a uniform rate with stirring over a period of 0.5-2 hours for each Feed. Following complete addition of the initiator solution (0-60 min after the end of the addition of the monomer mixture), the reactor is heated to 100-180° C. and stirring is continued for 5-90 minutes at the stated pressure, before a solution consisting of 5-50 parts by weight of di-tert-butyl peroxide in 5-50 parts by weight of butyl acetate is again added at a uniform rate over the course of 0.5-2 hours. Subsequently, the batch is held at the stated temperature and stated pressure for a further 0.5-2 hours. Thereafter, the reaction mixture is cooled to 25-80° C. and let down to atmospheric pressure.

As another example, a crosslinkable silane functional polymer is prepared as follows: A reactor is charged with 100-500 parts by weight of butyl acetate and this initial charge is heated to 90-160° C. The reactor is placed under pressure (1.5-6.5 bar). Thereafter, over a period of 4-7 hours, an initiator solution (50-100 parts by weight of di-tert-butyl peroxide in 50-100 parts by weight of butyl acetate) is metered in at a uniform rate with stirring. Starting 0-30 min after the start of initiator feed, Feed 1 composed of ethylenically unsaturated vinyl alkoxy silane monomers is metered in at a uniform rate with stirring over a period of 0.5-2 hours. Starting 0-30 min after the start of initiator feed, 500-1500 by weight of Feed 2 to 6 consisting of styrene, methyl methacrylate and ethylhexyl acrylate in weight ratio of 0.1 to 10 is metered in at a uniform rate with stirring over a period of 0.5-2 hours for each Feed. Following complete addition of the initiator solution (0-60 min after the end of the addition of the monomer mixture), the reactor is heated to 100-180° C. and stirring is continued for 5-90 minutes at the stated pressure, before a solution consisting of 5-50 parts by weight of di-tert-butyl peroxide in 5-50 parts by weight of butyl acetate is again added at a uniform rate over the course of 0.5-2 hours. Subsequently, the batch is held at the stated temperature and stated pressure for a further 0.5-2 hours. Thereafter, the reaction mixture is cooled to 25-80° C. and let down to atmospheric pressure.

As a further example, a crosslinkable silane functional polymer is prepared as follows:

A reactor is charged with 100-500 parts by weight of Shellsol A and this initial charge is heated to 90-160° C. The reactor is placed under pressure (1.5-6.5 bar). Thereafter, over a period of 4-7 hours, an initiator solution (50-100 parts by weight of di-tert-butyl peroxide in 50-100 parts by weight of Shellsol A) is metered in at a uniform rate with stirring. Starting 0-30 min after the start of initiator feed, Feed 1 composed of ethylenically unsaturated vinyl alkoxy silane monomers is metered in at a uniform rate with stirring over a period of 0.5-2 hours. Starting 0-30 min after the start of initiator feed, 500-1500 by weight of Feed 2 to 6 consisting of styrene, methyl methacrylate and hydroxypropyl methacrylate in weight ratio of 0.1 to 10 is metered in at a uniform rate with stirring over a period of 0.5-2 hours for each Feed. Following complete addition of the initiator solution (0-60 min after the end of the addition of the monomer mixture), the reactor is heated to 100-180° C. and stirring is continued for 5-90 minutes at the stated pressure, before a solution consisting of 5-50 parts by weight of di-tert-butyl peroxide in 5-50 parts by weight of Shellsol A is again added at a uniform rate over the course of 0.5-2 hours. Subsequently, the batch is held at the stated temperature and stated pressure for a further 0.5-2 hours. Thereafter, the reaction mixture is cooled to 25-80° C. and let down to atmospheric pressure.

The synthesis approach of acrylosilane polymer according to this invention decreased the residues of monomers (<5%) and the obtained acrylosilane polymer has a solid content of no less than 70% by weight and Tg of less than 15° C.

Monomer and/or Unsaturated Oligomer and/or Unsaturated Polymer

Any common monomers for preparing coating composition and their unsaturated oligomers as well as unsaturated polymers could be used here, such as (meth)acrylic acid esters, unsaturated carboxylic acids and unsaturated alcohols. Preferably said monomers are phenoxyethyl acrylate, 1,6-hexanediol diacrylate and trimethylopropane triacrylate, said unsaturated oligomer are polyurethane-modified acrylate oligomers, such as such as Laromer® UA 8987, Laromer® UA 19 T, Laromer® UA 9050 and Laromer® UA 9136, and polyester-modified acrylate oligomers, such as Laromer® PE 55 F, Laromer® PE 9121 and Laromer® PE 9105, and said unsaturated polymer is an unsaturated polyester.

Preferably, said monomer or unsaturated oligomer or unsaturated polymer has a weight average molecular weight of from 200 to 20000, a hydroxyl value from 0 to 350 mg KOH/g and an acid value from 0 to 150 mg KOH/g.

Preferably, said unsaturated polyester is prepared from a condensation of at least one monounsaturated linear aliphatic dicarboxylic acid or its anhydride and at least one saturated aliphatic diol. And more preferably, said unsaturated polyester is prepared from a condensation of at least one monounsaturated linear aliphatic dicarboxylic acid or its anhydride selected from maleic acid, maleic anhydride, itaconic acid, ithaconic anhydride, hexahydrophthalic acid, hexahydrophthalic anhydride and fumaric acid and at least one saturated aliphatic diol selected from neopentyl glycol, 1,4 butanediol, 1,6 hexane diol and cyclohexyl dimethanol.

As one example, an unsaturated polyester is prepared as follows:

200-500 parts by weight of trimethylol propane (TMP), 500-1000 parts by weight of itaconic acid (IA) and 300-600 parts by weight of 1,4-butanediol (BD) are charged to a stainless-steel reactor equipped with reflux condenser, water separator and N₂ inlet. This is followed by the addition of 5-50 parts by weight of xylene as entraining agent, 0.05-0.5 parts by weight of 2,6-Di-tert-butyl-4-methylphenol (BHT) as stabilizer and 0.5-1 parts by weight of tetra-n-butyl titanate (TBT) as catalyst. The resulting reaction mixture is heated for 2-8 hours under N₂. During the entire reaction time, the temperature of the reaction mixture does not exceed 200° C. After an acid number of 5-100 mg KOH/g is reached, the reaction mixture is cooled to 50-100° C. and the polymer is diluted by the addition of 300-700 parts by weight of butyl acetate (BA).

As another example, an unsaturated polyester is prepared as follows:

200-500 parts by weight of trimethylol propane (TMP), 400-800 parts by weight of maleic anhydride (MAH) and 400-800 parts by weight of neopentyl glycol (NPG) are charged to a stainless-steel reactor equipped with reflux condenser, water separator and N₂ inlet. This is followed by the addition of 5-50 parts by weight of xylene as entraining agent. The resulting reaction mixture is heated for 2-8 hours under N₂. During the entire reaction time, the temperature of the reaction mixture does not exceed 200° C. After an acid number of 5-50 mg KOH/g is reached, the reaction mixture is cooled to 50-100° C. and the polymer is diluted by the addition of 300-700 parts by weight of butyl acetate (BA).

As another example, an unsaturated polyester is prepared as follows:

200-500 parts by weight of trimethylol propane (TMP), 400-800 parts by weight of maleic anhydride (MAH) and 400-800 parts by weight of neopentyl glycol (NPG) are charged to a stainless-steel reactor equipped with reflux condenser, water separator and N₂ inlet. This is followed by the addition of 5-50 parts by weight of xylene as entraining agent 0.05-0.5 parts by weight of 2,6-Di-tert-butyl-4-methylphenol (BHT) as stabilizer. The resulting reaction mixture is heated for 2-8 hours under N₂. During the entire reaction time, the temperature of the reaction mixture does not exceed 200° C. After an acid number of 5-50 mg KOH/g is reached, the reaction mixture is cooled to room temperature. The solid content of the resulting polymer is 95-100%.

As another example, an unsaturated polyester is prepared as follows:

150-400 parts by weight of trimethylol propane (TMP), 400-800 parts by weight of itaconic acid (IA) and 200-600 parts by weight of 1,4-butanediol (BD) are charged to a stainless-steel reactor equipped with reflux condenser, water separator and N₂ inlet. This is followed by the addition of 5-50 parts by weight of xylene as entraining agent 0.1-1 parts by weight of 4-Methoxyphenol (MEHQ) as stabilizer. The resulting reaction mixture is heated for 2-8 hours under N₂. During the entire reaction time, the temperature of the reaction mixture does not exceed 230° C. After an acid number of 5-50 mg KOH/g is reached, the reaction mixture is cooled to room temperature.

As a further example, an unsaturated polyester is prepared as follows:

100-400 parts by weight of trimethylol propane, 300-600 parts by weight of itaconic acid, 200-500 parts by weight of 1,4-butandiol, 5-50 parts by weight of Xylene, 0.1-1 parts by weight of 4-Methoxyphenol (MEHQ) and 1-5 parts by weight of 2,6-Di-tert-butyl-4-methylphenol (BHT) have been placed in a reactor, heat up to 50-150° C. and kept for 0.5-2 hours. The temperature has been increased to 100-200° C. and kept for another hour before increasing to 220-260° C. and kept for 1-4 hours. Xylene has been distilled off during the reaction. Cooling to 50-100° C. and adding 200-400 parts by weight of hexohydrophthalic anhydride, 0.05-0.5 parts by weight of 2,6-Di-tert-butyl-4-methylphenol (BHT) and 0.05-0.5 parts by weight of 4-Methoxyphenol (MEHQ) to the mixture and heating up to 120-180° C. for several hours. Adding 400-800 parts by weight of Cadura E10P, 0.05-0.5 parts by weight of 2,6-Di-tert-butyl-4-methylphenol (BHT) and 0.05-0.5 parts by weight of 4-Methoxyphenol (MEHQ) to the reaction mixture over 0.5-3 hours and cool down to 25-80° C. and further adding 300-700 parts by weight of trimethylolpropane triacrylate and 300-700 parts by weight of 1,6-hexandiol diacrylate.

The obtained unsaturated polyester has a solid content of no less than 65% by weight and Tg of less than 100° C.

### Initiator and Catalyst

Any initiator commonly used for radical polymerization could be used here, such as dibenzoyl peroxide (BPO), azobisisobutyronitrile, ethyl-2-oxocyclopentanecarboxylate (EOC) and benzo pinacol (BP).

Any catalyst commonly used for silane condensation could be used here, such as phenyl acid phosphate (PAP), amine neutralized p-Toluenesulfonic acid (NARCURE 2500) and amine neutralized phosphate (NARCURE 4575).

### Dual-Reactive Coating Compositions

A dual-reactive coating composition is prepared by mixing

a). from 24% to 90% by weight of crosslinkable silane-functional monomer and/or oligomer and/or polymer;
b). from 9% to 75% by weight of one monomer and/or unsaturated oligomer and/or unsaturated polymer;
c). from 0.5% to 10% by weight of one initiator; and
d). from 0.5% to 10% by weight of one catalyst, all weight percentages are based on the total weight of the coating composition

Preferably, a dual-reactive coating composition is prepared by mixing

a). from 24% to 90% by weight of crosslinkable silane-functional monomer and/or oligomer and/or polymer;
b). from 9% to 75% by weight of unsaturated polyester and/or polyester-modified oligomer;
c). from 0.5% to 10% by weight of one initiator; and
d). from 0.5% to 10% by weight of one catalyst, all weight percentages are based on the total weight of the coating composition.

More preferably, a dual-reactive coating composition is prepared by mixing

a). from 24% to 90% by weight of crosslinkable silane-functional polymer;
b). from 9% to 75% by weight of unsaturated polyester;
c). from 0.5% to 10% by weight of one initiator; and
d). from 0.5% to 10% by weight of one catalyst, all weight percentages are based on the total weight of the coating composition.

As an example, the dual-reactive coating composition is prepared by mixing 24% to 90% by weight of acrylosilane polymers and 9% to 75% by weight of unsaturated polyesters are mixed with 0.5% to 10% by weight of initiator selected from dibenzoyl peroxide (BPO), Ethyl-2-oxocyclopentanecarboxylate (EOC) or benzo pinacol (BP) as well as 0.5% to 10% by weight of catalyst phenyl acid phosphate (PAP, IsleChem, LLC), diluted with butyl acetate to give a solid content of 50% by weight and stirred until an even mixture is obtained.

As another example, the dual-reactive coating composition is prepared by mixing 49% to 85% by weight of acrylosilane polymers and 14% to 50% by weight of unsaturated polyesters are mixed with 0.5% to 5% by weight of initiator selected from dibenzoyl peroxide (BPO), Ethyl-2-oxocyclopentanecarboxylate (EOC) or benzo pinacol (BP) as well as 0.5% to 5% by weight of catalyst phenyl acid phosphate (PAP, IsleChem, LLC), diluted with butyl acetate to give a solid content of 50% by weight and stirred until an even mixture is obtained.

As another example, the dual-reactive coating composition is prepared by mixing 24% to 90% by weight of acrylosilane polymers and 9% to 75% by weight of polyurethane and/or polyester-modified acrylate oligomers are mixed with 0.5% to 10% by weight of initiator selected from dibenzoyl peroxide (BPO), Ethyl-2-oxocyclopentanecarboxylate (EOC) or benzo pinacol (BP) as well as 0.5% to 10% by weight of catalyst phenyl acid phosphate (PAP, IsleChem, LLC), diluted with butyl acetate to give a solid content of 50% by weight and stirred until an even mixture is obtained.

As another example, the dual-reactive coating composition is prepared by mixing 49% to 85% by weight of acrylosilane polymers and 14% to 50% by weight of polyester-modified acrylate oligomers are mixed with 0.5% to 5% by weight of initiator selected from dibenzoyl peroxide (BPO), Ethyl-2-oxocyclopentanecarboxylate (EOC) or benzo pinacol (BP) as well as 0.5% to 5% by weight of catalyst phenyl acid phosphate (PAP, IsleChem, LLC), diluted with butyl acetate to give a solid content of 50% by weight and stirred until an even mixture is obtained.

As a another example, the dual-reactive coating composition is prepared by mixing 24% to 90% by weight of acrylosilane polymers and 9% to 75% by weight of (meth)acrylic acid ester momers selected from phenoxyethyl acrylate, 1,6-hexanediol diacrylate or trimethylopropane triacrylate are mixed with 0.5% to 10% by weight of initiator selected from dibenzoyl peroxide (BPO), Ethyl-2-oxocyclopentanecarboxylate (EOC) or benzo pinacol (BP) as well as 0.5% to 10% by weight of catalyst phenyl acid phosphate (PAP, IsleChem, LLC), diluted with butyl acetate to give a solid content of 50% by weight and stirred until an even mixture is obtained.

As a further example, the dual-reactive coating composition is prepared by mixing 49% to 85% by weight of acrylosilane polymers and 14% to 50% by weight of (meth)acrylic acid ester momers selected from phenoxyethyl acrylate, 1,6-hexanediol diacrylate or trimethylopropane triacrylate are mixed with 0.5% to 5% by weight of initiator selected from dibenzoyl peroxide (BPO), Ethyl-2-oxocyclopentanecarboxylate (EOC) or benzo pinacol (BP) as well as 0.5% to 5% by weight of catalyst phenyl acid phosphate (PAP, IsleChem, LLC), diluted with butyl acetate to give a solid content of 50% by weight and stirred until an even mixture is obtained.

The mixtures are applied on tin test panels by doctor blading, to give a wet film thickness of 200 um, and are placed at 140° C. for 20 min to get tack free films of about 35-55 um. After 3 days of post curing single layer tests for performance check are conducted by evaluating hardness (K-pendulum), crosslinking performance (MEK rub test), gel content as well as cracking performance (bending test). The test results show no cracking in bending tests, 60 to 140 in K Pendulum tests and 200 to 500 in MEK Rub tests.

The obtained dual-reactive coating compositions enable a balanced performance of flexibility and hardness and completely suppress brittleness and cracking of a topcoat or clearcoat.

### Roll-to-Roll Coating Compositions

Based on the dual-reactive coating composition, a roll-to-roll coating composition could be prepared by adding reactive diluent such as phenoxyethyl acrylate (Laromer® POEA), 1,6-hexanediol diacrylate and/or trimethylopropane triacrylateand additives such as HYDROPALAT®. The solid content of the obtained roll-to-roll coating composition is no less than 90% by weight and preferably no less than 95% by weight.

As an example, a roll-to-roll coating composition is prepared as follows:

40% to 60% by weight of aliphatic urethane acrylate resin (Laromer® UA 8987), 10% to 30% by weight of polyester-modified acrylate oligomer (Laromer® PE 55 F), 9% to 50% by weight of unsaturated silane-functional monomer (3-Methacryloxypropyl trimethoxysilane), 19.5% to 39.5% by weight of acrylate-based reactive diluent (1,6-Hexanediol diacrylate, HDDA), 0.5% to 10% by weight of catalyst (Narcure 2500, King Industries), 0.5% to 10% by weight of initiator (benzo pinacol, BP) and 0.5% to 10% by weight of additives of wetting agent (Hydropalat WE3220) are mixed evenly to obtain a roll-to-roll coating composition.

The coating composition was coated on tin panels using an Erichsen bar coater and placed at 140° C. for 20 min. After 3 days of post curing single layer tests for performance check are conducted by evaluating the hardness (Koenig's pendulum), crosslinking density (MEK double rub test), cupping performance (Erichson cupping) as well as gloss and haze measurement (specular reflection). The results show that the obtained roll-to-roll coating composition can deliver high solid content, exceptional high crosslinking performance, good appearance and cupping (Erichson index, EI).

### 1K Clearcoat Compositions

Based on the dual-reactive coating composition, a 1K clearcoat composition could be prepared by adding reactive diluent such as phenoxyethyl acrylate (Laromer® POEA), 1,6-hexanediol diacrylate and/or trimethylopropane triacrylate, additives such as BYK 3190 and co-solvent such as 1-butanol. The VOC of the obtained clearcoat composition is no more than 420 g/L and preferably no more than 350 g/L.

As an example, a 1K clearcoat composition is prepared as follows:

10% to 60% by weight of acrylate/styrene resin having silane functional groups, 10% to 60% by weight of unsaturated polyester resin, 19.5% to 69.5% by weight of acrylate-based reactive diluent (trimethylolpropane triacrylate, TMPTA), 4% to 10% by weight of silane-based sagging control agent (SCA), 1% to 10% by weight of catalyst (Narcure 4575, King Industries), 0.4% to 10% by weight of initiator (benzo pinacol, BP), 5% to 20% by weight of co-solvent (1-butanol) and 0.1% to 2% by weight of additives of leveling agent (BYK 3190) are mixed evenly to obtain a 1K clearcoat composition. The coating composition showed thixotropic behavior with a ratio of low- to high-shear viscosity of η2(shear rate=1s−1)η1(shear rate=1000s-1)>8. VOC value of the coating composition has been measured to be 325 g/L which is a strong reduction in VOC level compared to conventional 1K coating compositions (VOC=450-550 g/L).

The composition is sprayed on black basecoat coated tin panels and placed at 140° C. for 20 min. After 3 days of post curing single layer tests for performance check are conducted by evaluating the hardness (Koenig's pendulum), crosslinking density (MEK double rub test), alkali- and acid etch resistance, cupping performance (Erichson cupping), appearance (wave scan) as well as gloss and haze measurement (specular reflection). The results show that the obtained 1K clearcoat composition can deliver high solid content and low VOC value, exceptional high crosslinking performance, good appearance, cupping (Erichson index, EI) as well as acid and alkali etch resistance.

### Embodiment

The 1^{st} embodiment is a dual-reactive coating composition comprising

a). from 24% to 90% by weight of crosslinkable silane-functional monomer and/or oligomer and/or polymer;
b). from 9% to 75% by weight of one monomer and/or unsaturated oligomer and/or unsaturated polymer;
c). from 0.5% to 10% by weight of one initiator; and
d). from 0.5% to 10% by weight of one catalyst, all weight percentages are based on the total weight of the coating composition.

The 2^{nd} embodiment is a dual-reactive coating composition comprising

a). from 24% to 90% by weight of crosslinkable silane-functional monomer and/or oligomer and/or polymer;
b). from 9% to 75% by weight of unsaturated polyester and/or polyurethane-modified oligomer and/or polyester-modified oligomer;
d). from 0.5% to 10% by weight of one catalyst, all weight percentages are based on the total weight of the coating composition.

The 3^{rd} embodiment is a dual-reactive coating composition comprising

a). from 24% to 90% by weight of crosslinkable silane-functional polymer;
b). from 9% to 75% by weight of unsaturated polyester;
c). from 0.5% to 10% by weight of one initiator; and
d). from 0.5% to 10% by weight of one catalyst, all weight percentages are based on the total weight of the coating composition.

The 4^{th} embodiment is the dual-reactive coating composition according to any one of Embodiments 1 to 3, wherein said crosslinkable silane-functional polymer is prepared by polymerization of monomers comprising

i) from 20% to 50% by weight of vinyl alkoxy silane represented by Formula I

H₂C═CH—(CH₂)ₙ—Si—(R₁)ₘ(R₂)₃₋ₘ

Wherein R₁ is an aryl or alkyl group having C1-C6, R₂ is an alkoxyl group having C1-C6, m is 0 or 1 and n is an integer from 0 to 3;

ii) from 50% to 80% by weight of (meth)acrylate monomer; and
iii) from 0% to 30% by weight of styrenic monomer, all weight percentages are based on the total weight of the silane-functional polymer.

The 5^{th} embodiment is the dual-reactive coating composition according to any one of Embodiments 1 to 4, wherein said crosslinkable silane-functional polymer is prepared by polymerization of monomers comprising

i) from 20% to 50% by weight of vinyltrimethoxysilane;
ii) from 50% to 80% by weight of at least one (meth)acrylate monomer selected from methyl methacrylate, n-butyl acrylate, ethylhexyl acrylate and hydroxypropyl methacrylate; and
iii) from 0% to 30% by weight of styrene, all weight percentages are based on the total weight of the silane-functional polymer.

The 6^{th} embodiment is the dual-reactive coating composition according to any one of Embodiments 1 to 5, wherein said crosslinkable silane-functional oligomer or polymer has a weight average molecular weight below 30,000 and preferably below 20,000.

The 7^{th} embodiment is the dual-reactive coating composition according to any one of Embodiments 1 to 6, wherein said crosslinkable silane-functional polymer has a hydroxyl value from 0 to 150 mg KOH/g and an acid value from 0 to 50 mg KOH/g.

The 8^{th} embodiment is the dual-reactive coating composition according to any one of Embodiments 1 and 4 to 7, wherein said monomer or unsaturated oligomer or unsaturated polymer has a weight average molecular weight of from 200 to 20000.

The 9^{th} embodiment is the dual-reactive coating composition according to any one of Embodiments 1 and 4 to 8, wherein said monomer or unsaturated oligomer or unsaturated polymer has a hydroxyl value from 0 to 350 mg KOH/g and an acid value from 0 to 150 mg KOH/g.

The 10^{th} embodiment is the dual-reactive coating composition according to any one of Embodiments 2 to 3, wherein said unsaturated polyester is prepared from a condensation of at least one monounsaturated linear aliphatic dicarboxylic acid or its anhydride and at least one saturated aliphatic diol.

The 11^{th} embodiment is the dual-reactive coating composition according to Embodiment 10, wherein said unsaturated polyester is prepared from a condensation of at least one monounsaturated linear aliphatic dicarboxylic acid or its anhydride selected from maleic acid, maleic anhydride, itaconic acid, ithaconic anhydride, hexahydrophthalic acid, hexahydrophthalic anhydride and fumaric acid and at least one saturated aliphatic diol selected from neopentyl glycol, 1,4 butanediol, 1,6 hexane diol and cyclohexyl dimethanol.

The 12^{th} embodiment is the dual-reactive coating composition according to any one of Embodiments 1 to 11, wherein said initiator is at least selected from dibenzoyl peroxide (BPO), ethyl-2-oxocyclopentanecarboxylate (EOC) and benzo pinacol (BP).

The 13^{th} embodiment is the dual-reactive coating composition according to any one of Embodiments 1 to 12, wherein said catalyst is at least selected from phenyl acid phosphate (PAP), amine neutralized p-Toluenesulfonic acid (NARCURE 2500) and amine neutralized phosphate (NARCURE 4575).

The 14^{th} embodiment is the dual-reactive coating composition according to any one of Embodiments 1 to 13, wherein said crosslinkable silane-functional polymer is prepared by a method comprising two steps: in the first step, vinyl alkoxy silane monomers, (meth)acrylate monomers and optional styrenic monomers and initiator are blended with an organic solvent and heated, and in the second step, (meth)acrylate monomers and optional styrenic monomers and initiator are added, wherein in the second step, said (meth)acrylate monomers and optional styrenic monomers are added in no less than two batches, and the time between each batch is no less than half an hour and the weight ratio between (meth)acrylate monomers and optional styrenic monomers added in each batch is from 1:15 to 15:1.

The 15^{th} embodiment is the dual-reactive coating composition according to any one of Embodiments 1 to 14, wherein it further comprises silane-functional sagging control agent.

The 16^{th} embodiment is a film obtained from curing and drying of the dual-reactive coating composition according to any one of Embodiments 1 to 15.

The 17^{th} embodiment is a substrate coated with the dual-reactive coating composition according to any one of Embodiments 1 to 15.

The 18th embodiment is the substrate according to Embodiment 17, wherein said substrate is automobile or truck.

The 19^{th} embodiment is a process for preparing the dual-reactive coating composition according to claim 1 by mixing

a). from 24% to 90% by weight of crosslinkable silane-functional monomer and/or oligomer and/or polymer;
b). from 9% to 75% by weight of one monomer and/or unsaturated oligomer and/or unsaturated polymer;
c). from 0.5% to 10% by weight of one initiator; and
d). from 0.5% to 10% by weight of one catalyst, all weight percentages are based on the total weight of the coating composition.

The 20^{th} embodiment is a process for preparing the dual-reactive coating composition according to Embodiment 2 by mixing

a). from 24% to 90% by weight of crosslinkable silane-functional monomer and/or oligomer and/or polymer;
b). from 9% to 75% by weight of unsaturated polyester and/or polyurethane-modified oligomer and/or polyester-modified oligomer;
c). from 0.5% to 10% by weight of one initiator; and
d). from 0.5% to 10% by weight of one catalyst, all weight percentages are based on the total weight of the coating composition.

The 21^{st} embodiment is a process for preparing the dual-reactive coating composition according to Embodiment 3 by mixing

a). from 24% to 90% by weight of crosslinkable silane-functional polymer;
b). from 9% to 75% by weight of unsaturated polyester;
c). from 0.5% to 10% by weight of one initiator; and
d). from 0.5% to 10% by weight of one catalyst, all weight percentages are based on the total weight of the coating composition.

The 22^{nd} embodiment is a roll-to-roll coating composition comprising the dual-reactive coating composition according to any one of Embodiments 1 to 15, reactive diluent and additives, wherein the solid content of the obtained roll-to-roll coating composition is no less than 90% by weight and preferably no less than 95% by weight.

The 23^{rd} embodiment is a 1K clearcoat composition comprising the dual-reactive coating composition according to any one of Embodiments 1 to 15, reactive diluent, additives and co-solvent, wherein VOC of the obtained clearcoat composition is no more than 420 g/L and preferably no more than 350 g/L.

### EXAMPLE

The present invention will now be described with reference to Examples which are not intended to limit the present invention.

### Example 1-3: Preparation of a Vinyl Silane Containing Acrylate Polymer

A reactor is charged with 378 parts by weight of Shellsol A and this initial charge is heated to 145° C. The reactor is placed under pressure (3.5 bar). Thereafter, over a period of 5.38 hours, an initiator solution (82.9 parts by weight of di-tert-butyl peroxide in 68.6 parts by weight of Shellsol A) is metered in at a uniform rate with stirring. Starting 15 min after the start of initiator feed, Feed 1 composed of VTMS is metered in at a uniform rate with stirring over a period of 1 hour. Starting 15 min after the start of initiator feed, Feed 2-a to 2-e consisting of methyl methacrylate and n-butyl acrylate with compositions as set below in Table 1 is metered in at a uniform rate with stirring over a period of 1 hour for each Feed. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of Shellsol A is again added at a uniform rate over the course of 1.2 hours. Subsequently, the batch is held at the stated temperature and stated pressure for a further 1.1 hours. Thereafter, the reaction mixture is cooled to 60° C. and let down to atmospheric pressure. The solid content, number-average molecular weight, glass transition temperature as well as monomer residues of the resulting solution of a copolymer are given below in Table 2.

TABLE 1

| Feed | Component (g) | Example 1 | Example 2 | Example 3 |
|---|---|---|---|---|
| 1 | Vinyltrimethoxysilane | 329.6 | 494.4 | 659.2 |
| 2-a | Methyl methacrylate | 100.4 | 59.5 | 91.2 |
| | n-butyl acrylate | 100.4 | 59.5 | 91.2 |
| 2-b | Methyl methacrylate | 167.0 | 214.4 | 167.8 |
| | n-butyl acrylate | 167.0 | 214.4 | 167.8 |
| 2-c | Methyl methacrylate | 132.2 | 118.3 | 102.0 |
| | n-butyl acrylate | 132.2 | 118.3 | 102.0 |
| 2-d | Methyl methacrylate | 123.3 | 80.0 | 74.0 |
| | n-butyl acrylate | 123.3 | 80.0 | 74.0 |
| 2-e | Methyl methacrylate | 136.3 | 104.6 | 59.4 |
| | n-butyl acrylate | 136.3 | 104.6 | 59.4 |

TABLE 2

| | | Example 1 | Example 2 | Example 3 |
|---|---|---|---|---|
| Solid content (% by weight) | | 81.2 | 79.1 | 76.0 |
| Weight average molecular weight | | 5480 | 4800 | 3338 |
| (g/mol) | | | | |
| Tg (° C.) | | −9.6 | −15.2 | −9.6 |
| Residue | Vinyltrimethoxysilane | 0.11 | 0.22 | 0.03 |
| (%) | Methyl methacrylate | 0.04 | 0.12 | 0.33 |
| | n-butyl acrylate | 0.06 | 0.03 | 0.18 |

### Example 4-13: Preparation of a Vinyl Silane Containing Acrylate/Styrene Copolymer

A reactor is charged with 378 parts by weight of Shellsol A and this initial charge is heated to 145° C. The reactor is placed under pressure (3.5 bar). Thereafter, over a period of 5.38 hours, an initiator solution (82.9 parts by weight of di-tert-butyl peroxide in 68.6 parts by weight of Shellsol A) is metered in at a uniform rate with stirring. Starting 15 min after the start of initiator feed, Feed 1 composed of VTMS is metered in at a uniform rate with stirring over a period of 1 hour. Starting 15 min after the start of initiator feed, Feed 3-a to 3-e consisting of styrene, methyl methacrylate and n-butyl acrylate with compositions as set below in Table 3 is metered in at a uniform rate with stirring over a period of 1 hour for each Feed. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of Shellsol A is again added at a uniform rate over the course of 1.2 hours. Subsequently, the batch is held at the stated temperature and stated pressure for a further 1.1 hours. Thereafter, the reaction mixture is cooled to 60° C. and let down to atmospheric pressure. The solid content, number-average molecular weight, glass transition temperature as well as monomer residues of the resulting solution of a copolymer are given below in Table 4.

TABLE 3

| | | Example | Example | Example | Example | Example | Example | Example | Example | Example | Example |
|---|---|---|---|---|---|---|---|---|---|---|---|
| Feed | Component (g) | 4 | 5 | 6 | 7 | 8 | 9 | 10 | 11 | 12 | 13 |
| 1 | Vinyl- | 329.6 | 494.4 | 494.4 | 527.4 | 527.4 | 576.8 | 576.8 | 609.8 | 609.8 | 659.2 |
| | trimethoxysilane | | | | | | | | | | |
| 3-a | Styrene | 54.0 | 88.03 | 90.95 | 87.0 | 98.4 | 87.1 | 87.5 | 89.3 | 87.48 | 80.46 |
| | Methyl | 54.0 | 88.03 | 113.7 | 87.0 | 107.3 | 87.1 | 98.4 | 89.3 | 94.0 | 80.5 |
| | methacrylate | | | | | | | | | | |
| | n-butyl acrylate | 107.9 | 132.1 | 113.7 | 121.8 | 107.3 | 180.8 | 98.4 | 702.7 | 94.0 | 80.5 |
| 3-b | Styrene | 84.8 | 117.2 | 117.1 | 113.5 | 113.9 | 113.3 | 113.0 | 112.8 | 117.0 | 139.5 |
| | Methyl | 84.8 | 117.2 | 146.4 | 113.5 | 136.7 | 113.3 | 127.2 | 112.8 | 125.8 | 139.5 |
| | methacrylate | | | | | | | | | | |
| | n-butyl acrylate | 169.6 | 175.7 | 146.4 | 158.9 | 136.7 | 141.6 | 127.2 | 129.8 | 125.8 | 139.5 |
| 3-c | Styrene | 66.1 | 68.0 | 66.3 | 72.7 | 73.1 | 78.4 | 78.4 | 78.9 | 76.3 | 47.2 |
| | Methyl | 66.1 | 68.0 | 82.9 | 72.7 | 87.8 | 78.4 | 88.2 | 78.9 | 82.0 | 47.2 |
| | methacrylate | | | | | | | | | | |
| | n-butyl acrylate | 132.1 | 102.1 | 82.9 | 101.8 | 87.8 | 98.0 | 88.2 | 90.7 | 82.0 | 47.2 |
| 3-d | Styrene | 54.3 | 40.0 | 38.9 | 41.4 | 38.2 | 39.5 | 39.1 | 36.9 | 36.9 | 40.4 |
| | Methyl | 54.3 | 40.0 | 48.6 | 41.4 | 45.8 | 39.5 | 44.0 | 36.9 | 39.7 | 40.4 |
| | methacrylate | | | | | | | | | | |
| | n-butyl acrylate | 108.5 | 59.9 | 48.6 | 58.0 | 45.8 | 49.4 | 44.0 | 42.4 | 39.7 | 40.4 |
| 3-e | Styrene | 70.5 | 16.4 | 16.3 | 15.1 | 15.0 | 11.4 | 11.6 | 11.7 | 12.0 | 22.1 |
| | Methyl | 70.5 | 16.4 | 20.4 | 15.1 | 18.0 | 11.4 | 13.1 | 11.7 | 12.9 | 22.1 |
| | methacrylate | | | | | | | | | | |
| | n-butyl acrylate | 141.0 | 24.7 | 20.4 | 21.1 | 18.0 | 14.2 | 13.1 | 13.5 | 12.9 | 22.1 |

TABLE 4

| | | Example | Example | Example | Example | Example | Example | Example | Example | Example | Example |
|---|---|---|---|---|---|---|---|---|---|---|---|
| | | 4 | 5 | 6 | 7 | 8 | 9 | 10 | 11 | 12 | 13 |
| Solid content (% by weight) | | 80.3 | 75.7 | 76.8 | 75.5 | 75.6 | 75.6 | 75.2 | 74.2 | 75.6 | 77.3 |
| Weight average molecular | | 8669 | 6142.3 | 6540 | 5640 | 5370 | 5193 | 4837 | 4640 | 4591 | 4628 |
| weight (g/mol) | | | | | | | | | | | |
| Tg (° C.) | | −0.6 | 3.4 | 11.7 | 3.1 | 7.3 | 4.2 | 6.2 | 7.0 | 7.6 | 3.4 |
| Residue | Vinyl- | 0.34 | 1.1 | 0.68 | 1.46 | 1.4 | 1.58 | 1.65 | 2.14 | 1.72 | 1.48 |
| (%) | trimethoxysilane | | | | | | | | | | |
| | Styrene | <0.01 | <0.01 | <0.01 | <0.01 | <0.01 | <0.01 | <0.01 | <0.01 | <0.01 | <0.01 |
| | Methyl methacrylate | 0.01 | <0.01 | <0.01 | <0.01 | <0.01 | <0.01 | <0.01 | <0.01 | <0.01 | <0.01 |
| | n-butyl acrylate | <0.01 | <0.01 | <0.01 | <0.01 | <0.01 | <0.01 | <0.01 | <0.01 | <0.01 | 0.02 |

### Example 14-15: Preparation of a Vinyl Silane Containing Acrylate/Styrene/Ethylhexyl Acrylate Copolymer

A reactor is charged with 378 parts by weight of Shellsol A and this initial charge is heated to 145° C. The reactor is placed under pressure (3.5 bar). Thereafter, over a period of 5.38 hours, an initiator solution (82.9 parts by weight of di-tert-butyl peroxide in 68.6 parts by weight of Shellsol A) is metered in at a uniform rate with stirring. Starting 15 min after the start of initiator feed, Feed 1 composed of VTMS is metered in at a uniform rate with stirring over a period of 1 hour. Starting 15 min after the start of initiator feed, Feed 4-a to 4-e consisting of styrene, methyl methacrylate and ethylhexyl acrylate with compositions as set below in Table 5 is metered in at a uniform rate with stirring over a period of 1 hour for each Feed. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of Shellsol A is again added at a uniform rate over the course of 1.2 hours. Subsequently, the batch is held at the stated temperature and stated pressure for a further 1.1 hours. Thereafter, the reaction mixture is cooled to 60° C. and let down to atmospheric pressure. The solid content, number-average molecular weight, glass transition temperature as well as monomer residues of the resulting solution of a copolymer are given below in Table 6.

TABLE 5

| Feed | Component (g) | Example 14 | Example 15 |
|---|---|---|---|
| 1 | vinylthrimethoxysilane | 576.8 | 659.2 |
| 4-a | Styrene | 94.6 | 106.4 |
| | Methyl methacrylate | 94.6 | 106.4 |
| | Ethylhexyl acrylate | 118.2 | 106.4 |
| 4-b | Styrene | 115.4 | 117.2 |
| | Methyl methacrylate | 115.4 | 117.2 |
| | Ethylhexyl acrylate | 144.3 | 117.2 |
| 4-c | Styrene | 73.8 | 63.5 |
| | Methyl methacrylate | 73.8 | 63.5 |
| | Ethylhexyl acrylate | 92.2 | 63.5 |
| 4-d | Styrene | 33.9 | 28.1 |
| | Methyl methacrylate | 33.9 | 28.1 |
| | Ethylhexyl acrylate | 42.4 | 28.1 |
| 4-e | Styrene | 12.0 | 14.4 |
| | Methyl methacrylate | 12.0 | 14.4 |
| | Ethylhexyl acrylate | 14.9 | 14.4 |

TABLE 6

| | | Example 14 | Example 15 |
|---|---|---|---|
| Solid content (% by weight) | | 74.1 | 75.5 |
| Weight average molecular weight (g/mol) | | 4276 | 4276 |
| Tg (° C.) | | −5.9 | −4.0 |
| Residue | vinylthrimethoxysilane | 1.46 | 1.40 |
| (%) | Styrene | <0.01 | <0.01 |
| | Methyl methacrylate | <0.01 | 0.02 |
| | Ethylhexyl acrylate | 0.02 | 4.00 |

### Example 16: Preparation of a Vinyl Silane Containing Acrylate Polymer in Butyl Acetate

A reactor is charged with 378 parts by weight of butyl acetate and this initial charge is heated to 145° C. The reactor is placed under pressure (3.5 bar). Thereafter, over a period of 5.38 hours, an initiator solution (82.9 parts by weight of di-tert-butyl peroxide in 68.6 parts by weight of butyl acetate) is metered in at a uniform rate with stirring. After 15 of start of initiator feed, 659.2 parts by weight of VTMS is metered in at a uniform rate with stirring over a period of 1 hour. In the first step, a monomer mixture consisting of 91.2 parts by weight of methyl methacrylate and 91.2 parts by weight of n-butyl acrylate is simultaneously metered in at a uniform rate with stirring over a period of 1 hour. In the second step, a monomer mixture consisting of 167.8 parts by weight of methyl methacrylate and 167.8 parts by weight of n-butyl acrylate is metered in at a uniform rate with stirring over a period of 1 hour. In the third step, a monomer mixture consisting of 102 parts by weight of methyl methacrylate and 102 parts by weight of n-butyl acrylate is metered in at a uniform rate with stirring over a period of 1 hour. In the fourth step, a monomer mixture consisting of 74 parts by weight of methyl methacrylate and 74 parts by weight of n-butyl acrylate is metered in at a uniform rate with stirring over a period of 1 hour. In the fifth step, a monomer mixture consisting of 59.4 parts by weight of methyl methacrylate and 59.4 parts by weight of n-butyl acrylate is metered in at a uniform rate with stirring over a period of 1 hour. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of butyl acetate is again added at a uniform rate over the course of 1.2 hours. Subsequently, the batch is held at the stated temperature and stated pressure for a further 1.1 hours. Thereafter the reaction mixture is cooled to 60° C. and let down to atmospheric pressure. The solids content of the resulting solution of a copolymer is 73.0%. The copolymer possesses a weight-average molecular weight of 5002 g/mol. The glass transition temperature of the copolymer is −21.0° C. The monomer residues of methyl methacrylate, n-butyl acrylate and vinyltrimethoxysilane are 0.03%, <0.01% and 0.26%, respectively.

### Example 17-19: Preparation of a Vinyl Silane Containing Acrylate/Styrene Copolymer in Butyl Acetate

A reactor is charged with 378 parts by weight of butyl acetate and this initial charge is heated to 145° C. The reactor is placed under pressure (3.5 bar). Thereafter, over a period of 5.38 hours, an initiator solution (82.9 parts by weight of di-tert-butyl peroxide in 68.6 parts by weight of butyl acetate) is metered in at a uniform rate with stirring. Starting 15 min after the start of initiator feed, Feed 1 composed of VTMS is metered in at a uniform rate with stirring over a period of 1 hour. Starting 15 min after the start of initiator feed, Feed 3-f to 3-j consisting of styrene, methyl methacrylate and n-butyl acrylate with compositions as set below in Table 7 is metered in at a uniform rate with stirring over a period of 1 hour for each Feed. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of butyl acetate is again added at a uniform rate over the course of 1.2 hours. Subsequently, the batch is held at the stated temperature and stated pressure for a further 1.1 hours. Thereafter, the reaction mixture is cooled to 60° C. and let down to atmospheric pressure. The solid content, number-average molecular weight, glass transition temperature as well as monomer residues of the resulting solution of a copolymer are given below in Table 8.

TABLE 7

| | | Exam- | Exam- | Exam- |
|---|---|---|---|---|
| Feed | Component (g) | ple 17 | ple 18 | ple 19 |
| 1 | Vinylthrimethoxysilane | 494.4 | 576.8 | 659.2 |
| 3-f | Styrene | 88.03 | 87.1 | 80.5 |
| | Methyl methacrylate | 88.0 | 87.1 | 80.5 |
| | n-butyl acrylate | 132.1 | 108.8 | 80.5 |
| 3-g | Styrene | 117.2 | 113.3 | 139.5 |
| | Methyl methacrylate | 117.2 | 113.3 | 139.5 |
| | n-butyl acrylate | 175.7 | 141.6 | 139.5 |
| 3-h | Styrene | 68.0 | 78.4 | 47.2 |
| | Methyl methacrylate | 68.0 | 78.4 | 47.2 |
| | n-butyl acrylate | 102.1 | 98.0 | 47.2 |
| 3-i | Styrene | 40.0 | 39.5 | 40.4 |
| | Methyl methacrylate | 40.0 | 39.5 | 40.4 |
| | n-butyl acrylate | 59.9 | 49.4 | 40.4 |
| 3-j | Styrene | 16.4 | 11.4 | 22.1 |
| | Methyl methacrylate | 16.4 | 11.4 | 22.1 |
| | n-butyl acrylate | 24.7 | 14.2 | 22.1 |

TABLE 8

| | | Exam- | Exam- | Exam- |
|---|---|---|---|---|
| | | ple 17 | ple 18 | ple 19 |
| Solid content (% by weight) | | 74.7 | 73.8 | 72.5 |
| Weight average molecular weight (g/mol) | | 12260 | 9936 | 6224 |
| Tg (° C.) | | 1.7 | 4.8 | 1.8 |
| Residue | vinyltrimethoxysilane | 0.44 | 0.75 | 1.22 |
| (%) | styrene | <0.01 | <0.01 | <0.01 |
| | Methyl methacrylate | <0.01 | <0.01 | <0.01 |
| | n-butyl acrylate | <0.01 | <0.01 | <0.01 |

### Example 20-21: Preparation of a Vinyl Silane Containing Acrylate/Styrene/Ethylhexyl acrylate Copolymer in Butyl Acetate

A reactor is charged with 378 parts by weight of butyl acetate and this initial charge is heated to 145° C. The reactor is placed under pressure (3.5 bar). Thereafter, over a period of 5.38 hours, an initiator solution (82.9 parts by weight of di-tert-butyl peroxide in 68.6 parts by weight of butyl acetate) is metered in at a uniform rate with stirring. Starting 15 min after the start of initiator feed, Feed 1 composed of VTMS is metered in at a uniform rate with stirring over a period of 1 hour. Starting 15 min after the start of initiator feed, Feed 4-a to 4-e consisting of styrene, methyl methacrylate and ethylhexyl acrylate with compositions as set below in Table 9 is metered in at a uniform rate with stirring over a period of 1 hour for each Feed. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of butyl acetate is again added at a uniform rate over the course of 1.2 hours. Subsequently, the batch is held at the stated temperature and stated pressure for a further 1.1 hours. Thereafter, the reaction mixture is cooled to 60° C. and let down to atmospheric pressure. The solid content, number-average molecular weight, glass transition temperature as well as monomer residues of the resulting solution of a copolymer are given below in Table 10.

TABLE 9

| Feed | Component (g) | Example 20 | Example 21 |
|---|---|---|---|
| 1 | vinylthrimethoxysilane | 576.8 | 659.2 |
| 4-a | Styrene | 94.6 | 106.4 |
| | Methyl methacrylate | 94.6 | 106.4 |
| | Ethylhexyl acrylate | 118.2 | 106.4 |
| 4-b | Styrene | 115.4 | 117.2 |
| | Methyl methacrylate | 115.4 | 117.2 |
| | Ethylhexyl acrylate | 144.3 | 117.2 |
| 4-c | Styrene | 73.8 | 63.5 |
| | Methyl methacrylate | 73.8 | 63.5 |
| | Ethylhexyl acrylate | 92.2 | 63.5 |
| 4-d | Styrene | 33.9 | 28.1 |
| | Methyl methacrylate | 33.9 | 28.1 |
| | Ethylhexyl acrylate | 42.4 | 28.1 |
| 4-e | Styrene | 12.0 | 14.4 |
| | Methyl methacrylate | 12.0 | 14.4 |
| | Ethylhexyl acrylate | 14.9 | 14.4 |

TABLE 10

| | | Example 20 | Example 21 |
|---|---|---|---|
| Solid content (% by weight) | | 75.5 | 72.1 |
| Weight average molecular weight (g/mol) | | 8099 | 6315 |
| Tg (° C.) | | −4.5 | −0.3 |
| Residue | vinyltrimethoxysilane | 0.72 | 1.37 |
| (%) | Styrene | <0.01 | <0.01 |
| | Methyl methacrylate | <0.01 | <0.01 |
| | Ethylhexyl acrylate | 0.02 | <0.01 |

### Example 22-23: Preparation of a Vinyl Silane Containing Acrylate/Styrene/Hydroxy Functional Acrylate Copolymer

A reactor is charged with 378 parts by weight of Shellsol A and this initial charge is heated to 145° C. The reactor is placed under pressure (3.5 bar). Thereafter, over a period of 5.38 hours, an initiator solution (82.9 parts by weight of di-tert-butyl peroxide in 68.6 parts by weight of Shellsol A) is metered in at a uniform rate with stirring. Starting 15 min after the start of initiator feed, Feed 1 composed of VTMS is metered in at a uniform rate with stirring over a period of 1 hour. Starting 15 min after the start of initiator feed, Feed 5-a to 5-e consisting of styrene, methyl methacrylate and hydroxypropyl methacrylate with compositions as set below in Table 11 is metered in at a uniform rate with stirring over a period of 1 hour for each Feed. Following complete addition of the initiator solution (0.15 h after the end of the addition of the monomer mixture), the reactor is heated to 155° C. and stirring is continued for 45 minutes at the stated pressure, before a solution consisting of 27 parts by weight of di-tert-butyl peroxide in 22.4 parts by weight of Shellsol A is again added at a uniform rate over the course of 1.2 hours. Subsequently, the batch is held at the stated temperature and stated pressure for a further 1.1 hours. Thereafter, the reaction mixture is cooled to 60° C. and let down to atmospheric pressure. The solid content, number-average molecular weight, glass transition temperature as well as monomer residues of the resulting solution of a copolymer are given below in Table 12.

TABLE 11

| Feed | Component (g) | Example 22 | Example 23 |
|---|---|---|---|
| 1 | Vinylthrimethoxysilane | 164.8 | 329.6 |
| 5-a | Methyl methacrylate | 200.8 | 129.9 |
| | n-butyl acrylate | 178.4 | 113.7 |
| | Hydroxypropyl methacrylate | 22.4 | 16.2 |
| 5-b | Methyl methacrylate | 262.5 | 231.1 |
| | n-butyl acrylate | 233.2 | 202.2 |
| | Hydroxypropyl methacrylate | 29.1 | 28.9 |
| 5-c | Methyl methacrylate | 173.4 | 180.2 |
| | n-butyl acrylate | 154.1 | 157.7 |
| | Hydroxypropyl methacrylate | 19.3 | 22.5 |
| 5-d | Methyl methacrylate | 90.5 | 92.9 |
| | n-butyl acrylate | 81.4 | 81.3 |
| | Hydroxypropyl methacrylate | 10.0 | 11.6 |
| 5-e | Methyl methacrylate | 14.4 | 25.2 |
| | n-butyl acrylate | 13.1 | 22.0 |
| | Hydroxypropyl methacrylate | 1.5 | 3.1 |

TABLE 12

| | | Example 22 | Example 23 |
|---|---|---|---|
| Solid content (% by weight) | | 79.5 | 77.7 |
| Weight average molecular weight (g/mol) | | 15003 | 9195 |
| Tg (° C.) | | 9.3 | 6.0 |
| Residue | vinylthrimethoxysilane | 0.02 | 0.07 |
| (%) | n-Butyl acrylate | <0.01 | <0.01 |
| | Methyl methacrylate | <0.01 | <0.01 |
| | Hydroxypropyl methacrylate | <0.01 | <0.01 |

### Example 24: Unsaturated Polyester Based on Itaconic Acid in Butyl Acetate

342.3 parts by weight of trimethylolpropane (TMP), 819.2 parts by weight of itaconic acid (IA) and 536.2 parts by weight of 1,4-butanediol (BD) are charged to a stainless-steel reactor equipped with reflux condenser, water separator and N₂ inlet. This is followed by the addition of 20 parts by weight of xylene as entraining agent, 0.252 parts by weight of 2,6-Di-tert-butyl-4-methylphenol (BHT) as stabilizer and 0.756 parts by weight of tetra-n-butyl titanate (TBT) as catalyst. The resulting reaction mixture is heated for 5 hours under N₂. During the entire reaction time, the temperature of the reaction mixture does not exceed 200° C. After an acid number of 52 mg KOH/g is reached, the reaction mixture is cooled to 80° C. and the polymer is diluted by the addition of 580.4 parts by weight of butyl acetate (BA). The solids content of the resulting solution of polymer is 69.03%. The resulting unsaturated polyester possesses a number-average molecular weight of 509 g/mol, a weight-average molecular weight of 1260 g/mol, an OH value of 301.7 mg KOH/g and the glass transition temperature is 65.9° C.

### Example 25: Unsaturated Polyester Based on Maleic Anhydride in Butyl Acetate

341.3 parts by weight of trimethylol propane (TMP), 615.7 parts by weight of maleic anhydride (MAH) and 618 parts by weight of neopentyl glycol (NPG) are charged to a stainless-steel reactor equipped with reflux condenser, water separator and N₂ inlet. This is followed by the addition of 20 parts by weight of xylene as entraining agent. The resulting reaction mixture is heated for 4 hours under N₂. During the entire reaction time, the temperature of the reaction mixture does not exceed 200° C. After an acid number of 12 mg KOH/g is reached, the reaction mixture is cooled to 80° C. and the polymer is diluted by the addition of 525 parts by weight of butyl acetate (BA). The solids content of the resulting solution of polymer is 69.00%. The resulting unsaturated polyester possesses a number-average molecular weight of 801 g/mol, a weight-average molecular weight of 2047 g/mol, an OH value of 272.2 mg KOH/g and the glass transition temperature is 0.6° C.

### Example 26: Unsaturated Polyester Based on Maleic Anhydride

341.3 parts by weight of trimethylol propane (TMP), 615.7 parts by weight of maleic anhydride (MAH) and 618 parts by weight of neopentyl glycol (NPG) are charged to a stainless-steel reactor equipped with reflux condenser, water separator and N₂ inlet. This is followed by the addition of 20 parts by weight of xylene as entraining agent 0.158 parts by weight of 2,6-Di-tertbutyl-4-methylphenol (BHT) as stabilizer. The resulting reaction mixture is heated for 4 hours under N₂. During the entire reaction time, the temperature of the reaction mixture does not exceed 200° C. After an acid number of 17 mg KOH/g is reached, the reaction mixture is cooled to room temperature. The solid content of the resulting polymer is 100%. The resulting unsaturated polyester possesses a number-average molecular weight of 805 g/mol, a weight-average molecular weight of 1937 g/mol, an OH value of 264.4 mg KOH/g and the glass transition temperature is −14.0° C.

### Example 27: Unsaturated Polyester Based on Maleic Anhydride in Reactive Diluents

1595.2 parts by weight of Example 23 are charged to a stainless-steel reactor equipped with reflux condenser, water separator and N₂ inlet and heated to 80° C. Afterwards, the polymer is diluted by the addition of 262 parts by weight of hexanediol diacrylate (HDDA) and 262 parts by weight of trimethylolpropane triacrylate (TMPTA). The solids content of the resulting solution of polymer is 75.00%. The resulting unsaturated polyester possesses a number-average molecular weight of 805 g/mol, a weight-average molecular weight of 1937 g/mol, an OH value of 256.6 mg KOH/g and the glass transition temperature is −14.0° C.

### Example 28: Unsaturated Polyester Based on Itaconic Acid

273.8 parts by weight of trimethylol propane (TMP), 655.3 parts by weight of itaconic acid (IA) and 429.0 parts by weight of 1,4-butanediol (BD) are charged to a stainless-steel reactor equipped with reflux condenser, water separator and N₂ inlet. This is followed by the addition of 16 parts by weight of xylene as entraining agent 0.4 parts by weight of 4-Methoxyphenol (MEHQ) as stabilizer. The resulting reaction mixture is heated for 4 hours under N₂. During the entire reaction time, the temperature of the reaction mixture does not exceed 230° C. After an acid number of 43 mg KOH/g is reached, the reaction mixture is cooled to room temperature. The solid content of the resulting polymer is 100.00%. The resulting unsaturated polyester possesses a number-average molecular weight of 907 g/mol, a weight-average molecular weight of 2030 g/mol, an OH value of 255.6 mg KOH/g and the glass transition temperature is 9.6° C.

### Example 29: Unsaturated Polyester based on Itaconic Acid in Reactive Diluents

1374.5 parts by weight of unsaturated polyester obtained from Example 28 are charged to a stainless-steel reactor equipped with reflux condenser, water separator and N₂ inlet and heated to 80° C. Afterwards, the polymer is diluted by the addition of 363 parts by weight of hexanediol diacrylate (HDDA) and 363 parts by weight of trimethylolpropane triacrylate (TMPTA). The solids content of the resulting solution of polymer is 65.00%. The resulting unsaturated polyester possesses a number-average molecular weight of 805 g/mol, a weight-average molecular weight of 1937 g/mol, an OH value of 248.3 mg KOH/g and the glass transition temperature is 9.6° C.

### Example 30: Unsaturated Polyester based on Itaconic Acid and Hexahydrophthalic Anhydride with Hydrophobic Modification in Reactive Diluents

210 g of trimethylol propane, 503 g itaconic acid, 329 g 1,4-butandiol, 12 g Xylene, 0.5 g MEHQ and 1.5 g BHT have been placed in a reactor, heat up to 100° C. and kept for 1 hour. The temperature has been increased to 160° C. and kept for another hour before increasing to 230° C. and kept for 2 hours. Xylene has been distilled off during the reaction. Cooling to 80° C. and adding 322 g hexohydrophthalic anhydride, 100 mg BHT and 80 mg MEHQ (hydroquinone monomethyl ether) to the mixture and heating up to 140° C. for several hours. Adding 623 g Cadura E10P, 100 mg BHT and 80 mg MEHQ to the reaction mixture over 1.5 hours, cool down to 40° C. and adding 500 g trimethylolpropane triacrylate and 500 g 1,6-hexandiol diacrylate. The reaction leads to a solvent-free low viscous unsaturated polyester resin (67% in reactive diluents) with acid value of 10-50 mg KOH/g, hydroxy value of 100-300 mg KOH/g and glass transition temperature of −55° C.

### Example 31: Silane-based Sagging Control Agent (12 wt % in Butyl Acetate)

44.25 g of 3-Aminopropyltriethoxysilane is dissolved in 37.05 g of butylacetate and then given into a 1 L metal bucket which contains 370.43 g of butylacetate. This solution is mixed by a dissolver 2 min at 2000 rpm. Then 16.53 g of hexamethylene diisocyanate is dissolved in 31.74 g butylacetate and loaded into an automatic dosing machine. The liquid in the metal bucket is stirred by a dissolver with a velocity 2000 rpm. The isocyanate solution is then added droplet wise over the course of 20 minutes. After that step, the solution is kept in the disperser for 2 additional minutes. Total solid content 12 wt %, η₁(shear rate=1000s⁻¹)=46 mPa s, η₂(shear rate=1s⁻¹)=13759 mPa·s

### Example 32: Silane-based Sagging Control Agent (12 wt % in Butyl Acetate)

88.50 g of 3-Aminopropyltriethoxysilane is dissolved in 37.05 g of butylacetate and then given into a 1 L metal bucket which contains 293.78 g of butylacetate. This solution is mixed by a dissolver 2 min at 2000 rpm. Then 33.06 g of hexamethylene diisocyanate is dissolved in 47.61 g butylacetate and loaded into an automatic dosing machine. The liquid in the metal bucket is stirred by a dissolver with a velocity 2000 rpm. The isocyanate solution is then added dropwise over the course of 30 minutes. After that step, the solution is kept in the disperser for 2 additional minutes. Total solid content 24 wt %, η₁(shear rate=1000s⁻¹)=60 mPa s, η₂(shear rate=1s⁻¹)=16833 mPa

### Example 33 to 50: Dual-Reactive Coating Compositions

The components of Example 33 to 50 are mixed with initiator dibenzoyl peroxide (BPO), Ethyl-2-oxocyclopentanecarboxylate (EOC) or benzo pinacol (BP) as well as phenyl acid phosphate catalyst (PAP, IsleChem, LLC) as set below in the Table, diluted with butyl acetate to give a solid content of 50% by weight and stirred until an even mixture is obtained. The mixtures are applied on tin test panels by doctor blading, to give a wet film thickness of 200 nm, and are placed at 140° C. for 20 min to get tack free films of about 35-55 nm. After 3 days of post curing single layer tests for performance check are conducted by evaluating hardness (K-pendulum), crosslinking performance (MEK rub test), gel content as well as cracking performance (bending test). Values are given in below in Table 13. The dried and cured films of Examples 33 to 50 are obtained as tack-free transparent coatings.

TABLE 13

| | Components | | | | Performance | | |
|---|---|---|---|---|---|---|---|
| Example | Resin | | Initiator | Catalyst | K Pendulum | MEK Rub | Bending Test |
| 33 | 85 wt % of Sample 3# | 15 wt % of Sample 24# | 1 wt % of BPO | 3 wt % of PAP | 67 | 204 | Not cracking |
| 34 | 85 wt % of Sample 3# | 15 wt % of Sample 27# | 1 wt % of BPO | 3 wt % of PAP | 68 | 313 | Not cracking |
| 35 | 85 wt % of Sample 3# | 15 wt % of Sample 27# | 1 wt % of EOC | 3 wt % of PAP | 68 | 200 | Not cracking |
| 36 | 85 wt % of Sample 3# | 15 wt % of Sample 25# | 1 wt % of BP | 3 wt % of PAP | 70 | 258 | Not cracking |
| 37 | 85 wt % of Sample 3# | 15 wt % of Sample 27# | 1 wt % of BP | 3 wt % of PAP | 73 | 313 | Not cracking |
| 38 | 85 wt % of Sample | 15 wt % of Sample 24# | 1 wt % of BP | 3 wt % of PAP | 62 | 454 | Not cracking |
| 39 | 85 wt % of Sample | 15 wt % of Sample 25# | 1 wt % of BP | 3 wt % of PAP | 71 | 327 | Not cracking |
| 40 | 85 wt % of Sample | 15 wt % of Sample 27# | 1 wt % of BP | 3 wt % of PAP | 69 | 400 | Not cracking |
| 41 | 85 wt % of Sample | 15 wt % of Sample 24# | 1 wt % of BP | 3 wt % of PAP | 99 | 368 | Not cracking |
| 42 | 85 wt % of Sample | 15 wt % of Sample 26# | 1 wt % of BP | 3 wt % of PAP | 132 | 220 | Not cracking |
| 43 | 85 wt % of Sample | 15 wt % of Sample 27# | 1 wt % of BP | 3 wt % of PAP | 111 | 205 | Not cracking |
| 44 | 85 wt % of Sample | 15 wt % of Sample 28# | 1 wt % of BP | 3 wt % of PAP | 112 | 355 | Not cracking |
| 45 | 85 wt % of Sample | 15 wt % of Sample 29# | 1 wt % of BP | 3 wt % of PAP | 76 | 320 | Not cracking |
| 46 | 85 wt % of Sample | 15 wt % of Sample 24# | 1 wt % of BP | 3 wt % of PAP | 119 | 345 | Not cracking |
| 47 | 85 wt % of Sample | 15 wt % of Sample 26# | 1 wt % of BP | 3 wt % of PAP | 133 | 235 | Not cracking |
| 48 | 85 wt % of Sample | 15 wt % of Sample 27# | 1 wt % of BP | 3 wt % of PAP | 129 | 190 | Not cracking |
| 49 | 85 wt % of Sample | 15 wt % of Sample 28# | 1 wt % of BP | 3 wt % of PAP | 70 | 365 | Not cracking |
| 50 | 85 wt % of Sample | 15 wt % of Sample 29# | 1 wt % of BP | 3 wt % of PAP | 112 | 285 | Not cracking |

### Example 51-53: Preparation and Application of Roll-to-Roll Coating Composition

According to the amount given below in Table 14, aliphatic urethane acrylate resin (Laromer® UA 8987), polyester-modified acrylate oligomer (Laromer® PE 55 F, Laromer® PE 9121, Laromer® PE 9105), unsaturated silane-functional monomer (3-Methacryloxypropyl trimethoxysilane), acrylate-based reactive diluent (1,6-Hexanediol diacrylate, HDDA; Laromer® POEA), catalyst (Narcure 2500, King Industries), initiator (benzo pinacol, BP) and additives of wetting agent (Hydropalat WE3220) are mixed evenly to obtain a roll-to-roll coating composition as Example 51-53. The coating composition was coated on tin panels using an Erichsen bar coater and placed at 140° C. for 20 min. After 3 days of post curing single layer tests for performance check are conducted by evaluating the hardness (Koenig's pendulum), crosslinking density (MEK double rub test), cupping performance (Erichson cupping) as well as gloss and haze measurement (specular reflection). The dried and cured films of Examples 51 to 53 are obtained as tack-free transparent coatings. Values are given below in Table 14.

TABLE 14

| | | | Example 51 | Example 52 | Example 53 |
|---|---|---|---|---|---|
| Composition | Resin | Aliphatic urethane acrylate resin, Laromer ® UA 8987 | 53.9 | 55.3 | 55.3 |
| (g) | | Polyester-modified acrylate oligomer, Laromer ® PE | 13.5 | — | — |
| | | 55 F | | | |
| | | Polyester-modified acrylate oligomer, Laromer ® PE | — | 13.8 | — |
| | | 9121 | | | |
| | | Polyester-modified acrylate oligomer, Laromer ® PE | — | — | 13.8 |
| | | 9105 | | | |
| | Silane | 3-Methacryloxypropyl trimethoxysilane | 10.1 | 10.3 | 10.3 |
| | monomer | | | | |
| | Catalyst | NARCUR 2500 | 2.4 | 0.3 | 0.3 |
| | Initiator | Benzo pinacol | 3.0 | 2.7 | 2.8 |
| | Additive | Hydropalat WE3220 | 0.8 | 0.8 | 0.8 |
| | Reactive | HDDA (1,6-hexanediol diacrylate) | 16.3 | 16.7 | — |
| | diluent | Acrylic acid ester monomere Laromer ® POEA | — | — | 16.7 |

| | | | | |
|---|---|---|---|---|
| Performance | Solid Content (%) | 96.5 | 96.1 | 96.9 |
| | Koenigs Pendulum (oscillations) | 111 | 97 | 107 |
| | MEK Double Rub (times) | 500+ | 500+ | 500+ |
| | Gloss (% @20°) | 91 | 89 | 90 |
| | Haze | 15 | 18 | 16 |
| | Cupping El (mm) | 6.1 | 4.9 | 4.6 |

### Example 54: Preparation and Spray Application of 1K Clearcoat Composition

According to the amount given below in Table 15, acrylate/styrene resin having silane functional groups, unsaturated polyester resin, acrylate-based reactive diluent (trimethylolpropane triacrylate, TMPTA), silane-based sagging control agent (SCA), catalyst (Narcure 4575, King Industries), initiator (benzo pinacol, BP), co-solvent (1-butanol) and additives of leveling agent (BYK 3190) are mixed evenly to obtain a 1K clearcoat composition as Example 54. The coating composition showed thixotropic behavior with a ratio of low- to high-shear viscosity of η2(shear rate=1s−1)/η1(shear rate=1000s-1)>8. VOC value of the coating composition has been measured to be 325 g/L which is a strong reduction in VOC level compared to conventional 1K coating compositions (VOC=450-550 g/L). The composition is spray applied on black basecoat coated tin panels and placed at 140° C. for 20 min. After 3 days of post curing single layer tests for performance check are conducted by evaluating the hardness (Koenig's pendulum), crosslinking density (MEK double rub test), alkali- and acid etch resistance, cupping performance (Erichson cupping), appearance (wave scan) as well as gloss and haze measurement (specular reflection). The dried and cured film of Examples 62 is obtained as tack-free transparent coating on black basecoat. Values are given below in Table 15. From Example 54, it can be clearly seen that the invented technical approach can deliver high solid content and low VOC value, exceptional high crosslinking performance, good appearance, comparable cupping (Erichson index, EI) and better acid as well as alkali etch resistance if compared to conventional 1K polyurethane or acid/epoxy clearcoat.

TABLE 15

| | | | Exam- |
|---|---|---|---|
| | | | ple 54 |
| Composition | Resin | Example 18: Vinyl Silane | 37.6 |
| (g) | | Containing Acrylate/Styrene | |
| | | Copolymer | |
| | | Example 30: Unsaturated | 11.3 |
| | | Polyester | |
| | SCA | Example 31: Silane-based | 6.0 |
| | | Sagging Control Agent | |
| | Catalyst | NARCUR 4575 | 4.5 |
| | Initiator | Benzo pinacol | 1.1 |
| | Additive | BYK 3190 | 0.4 |
| | Reactive diluent | TMTPA (4,4′,4″- | 27.8 |
| | | Trimethyltriphenylamine) | |
| | Co-solvent | 1-Butanol | 11.3 |

| | | |
|---|---|---|
| Performance | Solid Content (%) | 67.2 |
| | Koenigs Pendulum (oscillations) | 113 |
| | MEK Double Rub (times) | 500+ |
| | Acid Resistance (gloss retention @20°) | 96.1 |
| | Alkali Resistance (gloss retention @20°) | 953 |
| | VOC (g/L) | 325 |
| | Gloss (% @20°) | 92 |
| | Haze | 13 |
| | Appearance (DOI) | 94 |
| | Lw | 2.5 |
| | Sw | 12.1 |
| | Cupping El (mm) | 6 |

### <Resin Characterization>

The skilled person is aware of methods for determining the acid value, OH value, epoxy equivalent weight, solid content as well as number-average and weight-average molecular weights. They are determined in accordance with the standards described hereinafter: The acid value is determined in accordance with DIN EN ISO 2114 (date: June 2002). The OH value is determined in accordance with DIN 53240-2 (date: November 2007). The epoxy equivalent weight is determined in accordance with DIN EN ISO 3001 (date: November 1999). The solid content was determined in accordance with DIN EN ISO 3251 (date: June 2008). The number-average and weight-average molecular weights are determined in accordance with DIN 55672-1 (date: August 2007).

### <Solid Content>

Solid contents of the clearcoat compositions of Example 51 to 54 is calculated based on the weight loss of the composition at 130° C. for 60 minutes.

### <Performance Tests>

### (1) Hardness

The pendulum damping test after Koenig or Persoz is used to mechanically measure the surface hardness of a coating. The hardness of the coating is determined by the number of oscillations made by the pendulum between two defined angles (6 to 3 degrees for Koenig pendulum or 12 to 4 degrees for Persoz pendulum). With increasing hardness of the coating surface, the number of oscillations is increasing. The methods are standardized in the specification ISO 1522.

### (2) Solvent Rub Test

To assess the crosslinking and to ensure the coating system has been cured, a solvent rub test is performed using methylethylketone (MEK) as the solvent. The test is used widely in the paint industry because it provides a quick relative estimation of degree of cure without having to wait for long-term exposure results. The rubs are counted as a double rub (one rub forward and one rub backward constitutes a double rub) which gives a measurable value for the MEK resistance and degree of cure. The MEK double rub values of conventional 2K polyurethane or acid/epoxy clearcoat is about 200 times.

### (3) Bending Test

Bending test is used to determine the effects of bending on the elasticity, adhesion and elongation properties of cured coatings on metal panels. The conical bending tester is composed of a frame that has a bending lever with a roller which pivots on a steel conical mandrel with a diameter from 3.2-38.1 mm. The specimen can be bent on part of, or along, the entire length of the mandrel, and the results (cracks) corresponding to different test diameters can be observed in a single operation.

### (4) VOC Test

To determine the volatile organic compounds (VOCs) emission of the coating compositions a gravimetric method was applied. The VOC content was measured on the basis of the weight loss of the composition when heated to 105° C. for 60 min.

### (5) Rheology Test

The thixotropic effect of the sagging control agents as well as the coating compositions was characterized by using an Anton Paar rheometer. The 2D rheology profile was measured by fast shear rate changes. The test consists of two intervals with two different shear rates (shear rate1=1 s⁻¹), shear rate2=1000 s⁻¹). The thixotropic index is defined as the ratio between the viscosity of a sample at a high (η2) and at a low (η1) shear.

### (6) Cupping Test

The Erichsen cupping is used to evaluate the flexibility by testing the resistance to failure of coatings. The test uses a 20-mm-diameter hemispherical punch to slowly draw the dried and cured coating on a metal panel at room temperature. The test is run until failure of the coating is observed and the indentation depth at failure (in mm) is quoted as the Erichsen index, IE. The IE of conventional coatings is >5 mm.

### (7) Appearance

The appearance of dried and cured coating is evaluated by its surface texture, which is measured by BYK wave-scan dual. Surface texture is a mixture of various textures, ranging from very fine to very course. BYK wave-scan dual measures the surface textures at different scale levels, which is differentiated to six categories, identified by wavelength (Du, Wa, Wb, Wc, Wd, We). Based on these measured data, Du, Lw, Sw are calculated by the equipment and denotes the appearance level of the pain. A lower Du, Lw, Sw value represents a better performance in appearance. Usually a good appearance performance is defined by Lw<5 and Sw<20 at the same time.

### (8) Gloss & Haze Measurement

The Gloss and Haze of the dried and cured coating is evaluated by measuring the specular reflection gloss of the surface by using a gloss meter. Gloss is determined by projecting a beam of light at a fixed intensity and angle onto the surface and measuring the amount of reflected light at an equal but opposite angle of 20° and 60°, respectively. Haze is caused by microscopic surface structure which slightly changes the direction of a reflected light causing a bloom adjacent to the specular (gloss) angle. The surface has less reflective contrast and a shallow milky effect. The gloss meter can quantify orange peel by measuring distinctness of image (DOI) as well as haze. Usually a good appearance performance is defined by DOI>90 and Haze<20 at the same time.

### (9) Acid Etch Resistance

Acid Etch Resistance is evaluated by 20° gloss retention after acid treatment. Acid treat met was created by immersing the coating into 0.35 M Fe(II)SO₄ solution in 0.5 M H₂SO₄. During the test the coating was completely covered by the acid and stored at 70° C. for 60 minutes. 20° gloss before and after acid treatment was compared. A higher gloss retention represents a better performance in acid etch resistance. The 20° gloss retention of conventional 2K polyurethane or acid/epoxy clearcoat is about 70%.

### (10) Alkali Etch Resistance

Alkali Etch Resistance is evaluated by 20° gloss retention after alkaline treatment. Alkaline treat met was created by immersing the coating into 1% sodium hydroxide solution. During the test the coating was completely covered by the alkaline solution and stored at 70° C. for 60 minutes. 20° gloss before and after alkaline treatment was compared. A higher gloss retention represents a better performance in alkali etch resistance. The 20° gloss retention of conventional 2K polyurethane or acid/epoxy clearcoat is about 60%.

1. A dual-reactive coating composition comprising:
a). from 24% to 90% by weight of crosslinkable silane-functional monomer and/or oligomer and/or polymer;
b). from 9% to 75% by weight of one monomer and/or unsaturated oligomer and/or unsaturated polymer;
c). from 0.5% to 10% by weight of one initiator; and
d). from 0.5% to 10% by weight of one catalyst, all weight percentages are based on the total weight of the coating composition.

2. A dual-reactive coating composition comprising:
a). from 24% to 90% by weight of crosslinkable silane-functional monomer and/or oligomer and/or polymer;
b). from 9% to 75% by weight of unsaturated polyester and/or polyurethane-modified oligomer and/or polyester-modified oligomer;
c). from 0.5% to 10% by weight of one initiator; and
d). from 0.5% to 10% by weight of one catalyst, all weight percentages are based on the total weight of the coating composition.

3. A dual-reactive coating composition comprising:
a). from 24% to 90% by weight of crosslinkable silane-functional polymer;
b). from 9% to 75% by weight of unsaturated polyester;
c). from 0.5% to 10% by weight of one initiator; and
d). from 0.5% to 10% by weight of one catalyst, all weight percentages are based on the total weight of the coating composition.

4. The dual-reactive coating composition according to claim 1, wherein said crosslinkable silane-functional polymer is prepared by polymerization of monomers comprising:
i) from 20% to 50% by weight of vinyl alkoxy silane represented by Formula I
H₂C═CH—(CH₂)ₙ—Si—(R₁)ₘ(R₂)₃₋ₘ
Wherein R₁ is an aryl or alkyl group having C₁-C₆, R₂ is an alkoxyl group having C₁-C₆, m is 0 or 1 and n is an integer from 0 to 3;
ii) from 50% to 80% by weight of (meth)acrylate monomer; and
iii) from 0% to 30% by weight of styrenic monomer, all weight percentages are based on the total weight of the silane-functional polymer.

5. The dual-reactive coating composition according to claim 1, wherein said crosslinkable silane-functional polymer is prepared by polymerization of monomers comprising:
i) from 20% to 50% by weight of vinyltrimethoxysilane;
ii) from 50% to 80% by weight of at least one (meth)acrylate monomer selected from the group consisting of methyl methacrylate, n-butyl acrylate, ethylhexyl acrylate and hydroxypropyl methacrylate; and
iii) from 0% to 30% by weight of styrene, all weight percentages are based on the total weight of the silane-functional polymer.

6. The dual-reactive coating composition according to claim 1, wherein said crosslinkable silane-functional oligomer or polymer has a weight average molecular weight below 30,000.

7. The dual-reactive coating composition according to claim 1, wherein said crosslinkable silane-functional polymer has a hydroxyl value from 0 to 150 mg KOH/g and an acid value from 0 to 50 mg KOH/g.

8. The dual-reactive coating composition according to claim 1, wherein said unsaturated monomer or oligomer or polymer has a weight average molecular weight of from 200 to 20000.

9. The dual-reactive coating composition according to claim 1, wherein said unsaturated monomer or oligomer or polymer has a hydroxyl value from 0 to 350 mg KOH/g and an acid value from 0 to 150 mg KOH/g.

10. The dual-reactive coating composition according to claim 2, wherein said unsaturated polyester is prepared from a condensation of at least one monounsaturated linear aliphatic dicarboxylic acid or its anhydride and at least one saturated aliphatic diol.

11. The dual-reactive coating composition according to claim 10, wherein said unsaturated polyester is prepared from a condensation of at least one monounsaturated linear aliphatic dicarboxylic acid or its anhydride selected from the group consisting of maleic acid, maleic anhydride, itaconic acid, itaconic anhydride, hexahydrophthalic acid, hexahydrophthalic anhydride and fumaric acid and at least one saturated aliphatic diol selected from the group consisting of neopentyl glycol, 1,4 butanediol, 1,6 hexane diol and cyclohexyl dimethanol.

12. The dual-reactive coating composition according to claim 1, wherein said initiator is at least selected from the group consisting of dibenzoyl peroxide (BPO), ethyl-2-oxocyclopentanecarboxylate (EOC) and benzo pinacol (BP).

13. The dual-reactive coating composition according to claim 1, wherein said catalyst is at least selected from the group consisting of phenyl acid phosphate (PAP), amine neutralized p-Toluenesulfonic acid (NARCURE 2500) and amine neutralized phosphate (NARCURE 4575).

14. The dual-reactive coating composition according to claim 1, wherein said crosslinkable silane-functional polymer is prepared by a method comprising two steps: in the first step, vinyl alkoxy silane monomers, (meth)acrylate monomers and optional styrenic monomers and initiator are blended with an organic solvent and heated, and in the second step, (meth)acrylate monomers and optional styrenic monomers and initiator are added, wherein in the second step, said (meth)acrylate monomers and optional styrenic monomers are added in no less than two batches, and the time between each batch is no less than half an hour and the weight ratio between (meth)acrylate monomers and optional styrenic monomers added in each batch is from 1:15 to 15:1.

15. The dual-reactive coating composition according to claim 1, wherein it further comprises silane-functional sagging control agent.

16. A film obtained from curing and drying of the dual-reactive coating composition according to claim 1.

17. A substrate coated with the dual-reactive coating composition according to claim 1.

18. The substrate according to claim 17, wherein said substrate is an automobile or a truck.

19. A process for preparing the dual-reactive coating composition according to claim 1 by mixing:
a). from 24% to 90% by weight of crosslinkable silane-functional monomer and/or oligomer and/or polymer;
b). from 9% to 75% by weight of one monomer and/or unsaturated oligomer and/or unsaturated polymer;
c). from 0.5% to 10% by weight of one initiator; and
d). from 0.5% to 10% by weight of one catalyst, all weight percentages are based on the total weight of the coating composition.

20. A process for preparing the dual-reactive coating composition according to claim 2 by mixing:
a). from 24% to 90% by weight of crosslinkable silane-functional monomer and/or oligomer and/or polymer;
b). from 9% to 75% by weight of unsaturated polyester and/or polyurethane-modified oligomer and/or polyester-modified oligomer;
c). from 0.5% to 10% by weight of one initiator; and
d). from 0.5% to 10% by weight of one catalyst, all weight percentages are based on the total weight of the coating composition.

21. A process for preparing the dual-reactive coating composition according to claim 3 by mixing:
a). from 24% to 90% by weight of crosslinkable silane-functional polymer;
b). from 9% to 75% by weight of unsaturated polyester;
c). from 0.5% to 10% by weight of one initiator; and
d). from 0.5% to 10% by weight of one catalyst, all weight percentages are based on the total weight of the coating composition.

22. A roll-to-roll coating composition comprising the dual-reactive coating composition according to claim 1, reactive diluent and additives, wherein the solid content of the obtained roll-to-roll coating composition is no less than 90% by weight.

23. A 1K clearcoat composition comprising the dual-reactive coating composition according to claim 1, reactive diluent, additives and co-solvent, wherein VOC (volatile organic compound) of the obtained clearcoat composition is no more than 420 g/L.
